(19) United States
(12) Patent Application Publication
(10) Pub. No.: US 2026/0143396 A1
(43) Pub. Date: May 21, 2026

(54) METHOD AND APPARATUS FOR KEY SYNCHRONIZATION AND KEY UPDATE AND KEY DISTRIBUTION

(71) Applicant: Samsung Electronics Co., Ltd., Suwon-si, Gyeonggi-do (KR)

(72) Inventors: Rajavelsamy RAJADURAI, Bangalore (IN); Nivedya Parambath SASI, Bangalore (IN); Rohini RAJENDRAN, Bangalore (IN)

(21) Appl. No.: 19/120,989

(22) PCT Filed: Nov. 1, 2023
(86) PCT No.: PCT/KR2023/017246

§ 371 Date: Apr. 14, 2025

(30) Foreign Application Priority Data
Nov. 3, 2022 (IN) 202241062930
Nov. 4, 2022 (IN) 202241063150
Nov. 4, 2022 (IN) 202241063155
Oct. 16, 2023 (IN) 2022 41062930
Oct. 16, 2023 (IN) 2022 41063155

(51) Int. Cl. H04W 36/08; H04W 12/0431; H04W 12/069

(52) U.S. Cl. CPC H04W 36/087; H04W 12/0431; H04W 12/069

(57) ABSTRACT

The disclosure relates to a 5G or 6G communication system for supporting a higher data transmission rate. Embodiments disclosed herein provide a method for key synchronization for integrated access and backhaul (IAB) migration in a wireless network (600) by a source IAB Donor-Control Unit (CU) (214). The method includes detecting a migration of an IAB-MT (504) from a source IAB Donor-CU (214) to a target IAB Donor-CU node (224). The IAB-MT remains connected to the source IAB Donor-CU (214) via a F1 connection and establishes radio resource control (RRC) connection with the target IAB Donor-CU (224). Further, the method includes retaining a security context associated with the F1 connection of the IAB-MT based on the detection. Further, the method includes migrating the IAB-MT from the source IAB Donor-CU (214) to the target IAB Donor-CU (224) by establishing a secure RRC connection between the IAB-MIT and the target IAB Donor-CU (224).

### TECHNICAL FIELD

The embodiments disclosed herein generally relate to a field of a wireless network, and more specifically related relate to a system and a method for key synchronization for integrated access and backhaul (IAB) migration in the wireless network.

The embodiments disclosed herein generally relate to a field of a wireless network, and more particularly, to a system and a method for performing key update and distribution in a Multi-Operator Core Network (MOCN).

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

An objective of the present disclosure is to provide a method and a wireless network for key synchronization for integrated access and backhaul (IAB) migration.

Another objective of the present disclosure is to provide that a IKEv2 procedure between an IAB-node and an IAB-donor-CU using a dynamic PSK associated with an old IP address as a static PSK for the corresponding new IP address during IAB inter-CU topology adaptation procedures.

Another objective of the present disclosure is to ensure a security protection in a migration scenario by performing the IKEv2 procedure between IAB-node and the IAB-donor-CU using the dynamic PSK associated with the old IP address as the static PSK for the corresponding new IP address.

Another objective herein is to provide mapping of old and new IP address assigned by the source and target IAB-donor-CU by at least one of target IAB-donor-CU and IAB-MT.

Another objective herein is to associate a static PSK with the new IP address when IAB-MT is migrated from source IAB-donor-CU to target IAB-donor-CU.

Another principle objective of the present disclosure is to provide a method for performing key update and distribution in a MOCN when a service layer protection is supported.

An objective of the present disclosure is to address a MTK refresh/MTK update mechanism for PLMNs, which are under the MOCN, where AF apparatus needs to update the MTK for all PLMNs participating in the MOCN even if the key updates is requested by a particular PLMN.

Another objective of the present disclosure is to propose the network function to trigger the key update procedure with the AF in the MOCN.

Another objective of the present disclosure is to detect a method for providing the MTK keys to the PLMNs with/without MOCN capability.

### Solution to Problem

Embodiments disclosed herein provide a method for key synchronization for IAB migration in a wireless network. The method includes detecting, by a source IAB Donor-Control Unit (CU), a migration of an IAB-MT from a source IAB Donor-CU node to a target IAB Donor-CU node. The IAB-MT remains connected to the source IAB Donor-CU via a F1 connection and establishes radio resource control (RRC) connection with the target IAB Donor-CU node. Further, the method includes retaining, by the source IAB donor CU, a security context associated with the F1 connection of the IAB-MT based on the detection. Further, the method includes migrating, by the source IAB donor CU, the IAB-MT from the source IAB Donor-CU node to the target IAB Donor-CU node by establishing a secure RRC connection between the IAB-MT and the target IAB Donor-CU.

In an embodiment, establishing the secure RRC connection between the IAB-MT and the target IAB Donor-CU node includes configuring, by the target IAB Donor-CU, at least one new IP address for the F1 connection to the migrated IAB-MT, mapping, by the target IAB Donor-CU, at least one old IP address associated with the F1 connection with the source IAB Donor-CU node and the at least one new IP address configured by the target IAB Donor-CU, providing, by the target IAB Donor-CU, the mapping information of the at least one old IP address and the at least one new IP address to at least one of: the IAB-MT and the source IAB Donor-CU node, receiving, by the IAB-MT and the source IAB Donor-CU node, the mapping information of the at least one old IP address and the at least one new IP address from the target IAB Donor-CU, sending, by the migrated IAB-MT, an F1AP gNB-DU CONFIGURATION UPDATE message to the source IAB Donor-CU, wherein the F1AP gNB-DU CONFIGURATION UPDATE message comprises the at least one new IP address corresponding to a migrated path with the target IAB Donor-CU mapped with the at least one old IP address configured by the target IAB Donor-CU, identifying, by the source IAB Donor-CU, the security context based on the gNB-DU ID and the mapping of: the at least one new IP address and the at least one old IP address, wherein the security context comprises a Pre-Shared Key (K_{IAB}), and establishing, by the migrated IAB-MT, the secure F1 connection using a IKEv2 with the source IAB Donor-CU node and the PSK associated with the at least one old IP address.

In an embodiment, the mapping is performed, based on a Transport Network Layer (TNL) address index, by mapping, by the target IAB Donor-CU, the at least one old IP address to the at least one new IP address based on at least one of: an ascending indexing pattern or a descending indexing pattern.

Embodiments disclosed herein provide a source IAB Donor-CU for key synchronization for IAB migration in a wireless network. The source IAB Donor-CU includes an IAB migration key synchronization controller communicatively coupled to a memory and a processor. The IAB migration key synchronization controller is configured to detect a migration of the IAB-MT from the source IAB Donor-CU node to a target IAB Donor-CU node. The IAB-MT remains connected to the source IAB Donor-CU via a F1 connection and establishes a RRC connection with the target IAB Donor-CU node. Further, the IAB migration key synchronization controller is configured to retain a security context associated with the F1 connection of the IAB-MT based on the detection. Further, the IAB migration key synchronization controller is configured to migrate the IAB-MT from the source IAB Donor-CU node to the target IAB Donor-CU node by establishing a secure RRC connection between the IAB-MT and the target IAB Donor-CU.

Embodiments disclosed herein provide a wireless network for key synchronization for IAB migration. The wireless network includes an IAB-MT, a source IAB parent node communicatively coupled the IAB-MT, a target IAB parent node, and a source IAB Donor-CU communicatively coupled to the source IAB parent node and the target IAB parent node. The source IAB Donor-CU includes an IAB migration key synchronization controller communicatively coupled to a memory and a processor. The IAB migration key synchronization controller is configured to detect a migration of the IAB-MT from the source IAB Donor-CU node to a target IAB Donor-CU node. The IAB-MT remains connected to the source IAB Donor-CU via a F1 connection and establishes the RRC connection with the target IAB Donor-CU node. Further, the IAB migration key synchronization controller is configured to retain a security context associated with the F1 connection of the IAB-MT based on the detection. Further, the IAB migration key synchronization controller is configured to migrate the IAB-MT from the source IAB Donor-CU node to the target IAB Donor-CU node by establishing a secure RRC connection between the IAB-MT and the target IAB Donor-CU.

Embodiments disclosed herein provide a method for performing key update and distribution in a MOCN when a service layer protection is supported. The method includes determining, by a Core Network (CN) apparatus, a need for a Multicast Broadcast Service (MBS) key update in at least one first network apparatus or at least one second network apparatus from a plurality of network apparatuses. Further, the method includes triggering, by the CN apparatus, a key update procedure for a MBS Traffic Key (MTK) and a MTK ID at the at least one first network apparatus or the at least one second network apparatus from the plurality of network apparatuses. Further, the method includes receiving, by an AF apparatus, a key update request message from the at least one first network apparatus or the at least one second network apparatus from the plurality of network apparatuses to provide an updated MBS Traffic Key (MTK) and the MTK ID common to the CN apparatus participating in the MOCN. Further, the method includes generating, by the AF apparatus, a new MTK and a new MTK ID common to the participating CN apparatus in the MOCN. The new MBS Traffic key is derived based on the key update request message received from the at least one first network apparatus or the at least one second network apparatus from the plurality of network apparatuses. Further, the method includes sending, by the AF apparatus, the new MTK to the at least one first network apparatus and the at least one second network apparatus via the CN apparatus. Further, the method includes receiving, by the CN apparatus, the at least one first network apparatus or the at least one second network apparatus, the new MTK and the new MTK ID common to the participating CN apparatus in the MOCN.

In an embodiment, the key update request message is received from a Multicast-Broadcast Service Function (MBSF) or a Multicast-Broadcast Service Transport Function (MBSTF) in the at least one first network apparatus.

In an embodiment, the need for a Multicast Broadcast Service (MBS) key update is triggered based on an event. The event includes at least one of an expiry of the MTK, the MTK is about to expire, a change of authorization information, a trigger based on a local policy, use of the MTK for a predefined time period.

In an embodiment, the key update request message includes at least one of: a Nmbsmf_TMGI_Allocate request message, a Nmbsmf request message, and a Nnef service request message.

In an embodiment, the key update response message includes at least one of a Nmbsmf_TMGI_Allocate response message, a Nmbsmf response message and a Nnef service response message.

In an embodiment, the updated MBS Traffic Key (MTK) in the at least one first network apparatus or the second network apparatus is sent using at least one of a Nnef_MBSSession_create request or a Nnef_MBSKeyRegister request or a Nnef_MBSSession_Update request.

In an embodiment, the new MTK is sent to the at least one first network apparatus in a key update response message.

In an embodiment, the new MTK is sent to the at least one second network apparatus in a MBS session update service operation message.

In an embodiment, the MTK update request message includes an identifier of the MBS session.

Embodiments disclosed herein provide a MOCN for performing key update and distribution. The MOCN includes an AF apparatus and a CN apparatus. The CN apparatus includes a MOCN controller communicatively coupled to a memory and a processor. The MOCN controller is configured to determine a need for a MBS key update in at least one first network apparatus or at least one second network apparatus from a plurality of network apparatuses. Further, the MOCN controller is configured to trigger update procedure for a MTK and a MTK ID at the at least one first network apparatus or the at least one second network apparatus from the plurality of network apparatuses key. The AF apparatus includes a MOCN controller communicatively coupled to a memory and a processor. The MOCN controller is configured to receive a key update request message from the at least one first network apparatus or the at least one second network apparatus from the plurality of network apparatuses to provide an updated MTK and the MTK ID common to the CN apparatus participating in the MOCN. Further, the MOCN controller is configured to generate a new MTK and a new MTK ID common to the participating CN apparatus in the MOCN. The new MBS Traffic key is derived based on the key update request message received from the at least one first network apparatus or the at least one second network apparatus from the plurality of network apparatuses. Further, the MOCN controller is configured to send the new MTK to the at least one first network apparatus and the at least one second network apparatus via the CN apparatus. The MOCN controller of the CN apparatus receives the at least one first network apparatus or the at least one second network apparatus, the new MBS Traffic Key (MTK) and the new MTK ID common to the participating CN apparatus in the MOCN.

Embodiments disclosed herein provide a method for performing key update and distribution in a MOCN, when a service layer protection is supported. The method includes receiving, by an AF apparatus, a key update request message from at least one first network apparatus or at least one second network apparatus from a plurality of network apparatuses to provide an updated MTK and a MTK ID common to a CN apparatus participating in the MOCN. Further, the method includes generating, by the AF apparatus, a new MTK and a new MTK ID common to the participating CN apparatus in the MOCN. The new MBS Traffic key is derived based on the key update request message received from the at least one first network apparatus or the at least one second network apparatus from the plurality of network apparatuses. Further, the method includes sending, by the AF apparatus, the new MTK to the at least one first network apparatus and the at least one second network apparatus via the CN apparatus.

In an embodiment, the key update request message is received from the at least one first network apparatus or the at least one second network apparatus by determining a need for a MBS key update by using the CN apparatus, and triggering a key update procedure for the MTK and the MTK ID by using the CN apparatus.

Embodiments disclosed herein provide an AF apparatus for performing key update and distribution in a MOCN. The AF apparatus includes a MOCN controller communicatively coupled to a memory and a processor. The MOCN controller is configured to receive a key update request message from at least one first network apparatus or at least one second network apparatus from a plurality of network apparatuses to provide an updated MTK and a MTK ID common to a CN apparatus participating in the MOCN. Further, the MOCN controller is configured to generate a new MTK and a new MTK ID common to the participating CN apparatus in the MOCN. The new MBS Traffic key is derived based on the key update request message received from the at least one first network apparatus or the at least one second network apparatus from the plurality of network apparatuses. Further, the MOCN controller is configured to send the new MTK to the at least one first network apparatus and the at least one second network apparatus via the CN apparatus.

Embodiments disclosed herein provide a method for performing key update and distribution in a MOCN when a service layer protection is supported. The method includes determining, by a CN apparatus, a need for a MBS key update in least one first network apparatus or at least one second network apparatus from a plurality of network apparatuses. Further, the method includes triggering, by the CN apparatus, a key update request message for a MBS Traffic Key (MTK) and a MTK ID based on the determined need. Further, the method includes receiving, by the CN apparatus, a new MBS Traffic Key (MTK) and a new MTK ID common to the CN apparatus participating in the MOCN.

In an embodiment, the new MTK and the new MTK ID common to the CN apparatus participating in the MOCN is received by receiving a key update request message from the at least one first network apparatus or the at least one second network apparatus to provide an updated MTK and the MTK ID common to the CN apparatus participating in the MOCN by using an AF apparatus, generating a new MTK and a new MTK ID common to the participating CN apparatus in the MOCN, and sending the new MTK to the at least one first network apparatus and the at least one second network apparatus via the CN apparatus. The new MBS Traffic key is derived based on the key update request message received from the at least one first network apparatus or the at least one second network apparatus from the plurality of network apparatuses by using the AF apparatus.

Embodiments disclosed herein provide a CN apparatus for performing key update and distribution in a MOCN when a service layer protection is supported. The CN apparatus includes a MOCN controller communicatively coupled to a memory and a processor. The MOCN controller is configured to determine a need for a MBS key update in least one first network apparatus or at least one second network apparatus from a plurality of network apparatuses. Further, the MOCN controller is configured to trigger a key update request message for a MTK and a MTK ID based on the determined need. Further, the MOCN controller is configured to receive a new MTK and a new MTK ID common to the CN apparatus participating in the MOCN.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

For IAB inter-CU topology adaptation procedures, new IKEv2 procedure between IAB-node and the IAB-donor-CU is performed using the dynamic PSK associated with the old IP address as the static PSK for the corresponding new IP address. The solution ensures the security protection in migration scenario by performing new IKEv2 procedure between IAB-node and the IAB-donor-CU is performed using the dynamic PSK associated with the old IP address as the static PSK for the corresponding new IP address.

Embodiments of the present invention provide a method for performing key update and distribution in a MOCN when a service layer protection is supported.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates a schematic of IAB architecture, according to the prior art;

FIG. 2 illustrates a sequence diagram of an IAB inter-CU topology adaptation procedure, according to the prior art;

FIG. 3 illustrates a sequence diagram of an IAB inter-CU topology adaptation procedure with a descendant IAB-node, according to the prior art;

FIG. 4 illustrates a sequence diagram of an IAB inter-CU backhaul RLF recovery procedure for an IAB-node in a SA mode, according to the prior art;

FIG. 5 illustrates a schematic of IAB migration, according to the prior art;

FIG. 6 illustrates a sequence diagram of PSK derivation from KNG-RAN* during IAB migration, according to the embodiments as disclosed in herein.

FIG. 7 shows various hardware components of a source IAB Donor-Control Unit (CU), according to the embodiments as disclosed herein.

FIG. 8 is a flow chart illustrating a method for key synchronization for IAB migration in a wireless network, according to the embodiments as disclosed herein.

FIG. 9 illustrates a 5G MOCN in which multiple CNs are connected to the same NG-RAN, according to the prior arts;

FIG. 10 shows a schematic diagram illustrating a method for performing key generation and key distribution in both control plane and user plane when there is no network sharing optimization, according to the prior arts;

FIG. 11 shows a schematic diagram of a method for performing MTK generation and distribution for a MOCN deployment scenario, according to the prior arts;

FIG. 12 shows a schematic diagram of a method for triggering MTK update/refresh for the MOCN scenario by a MBSTF/MBSF/AF, according to the embodiments as disclosed herein;

FIG. 13 illustrates an overview of the MOCN for performing key update and distribution, according to the embodiments as disclosed herein;

FIG. 14 is a flow chart illustrating a method for performing key update and distribution in the MOCN, when a service layer protection is supported, according to the embodiments as disclosed herein;

FIG. 15 is a flow chart illustrating a method, implemented by the AF apparatus, for performing key update and distribution in the MOCN when the service layer protection is supported, according to the embodiments as disclosed herein; and

FIG. 16 is a flow chart illustrating a method, implemented by the CN apparatus, for performing key update and distribution in the MOCN when the service layer protection is supported, according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and con-structions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The terms “PSK”, “K_{IAB} PSK”, K_{IAB}, K_{IAB} (PSK), means the same, the Pre-shared Secret Key (PSK) used for IKEv2 authentication, and used interchangeably throughout in this document.

Embodiments disclosed herein provide a method for key synchronization for IAB migration in a wireless network. The method includes detecting, by a source IAB Donor-CU, an migration of a IAB-MT from a source IAB Donor-CU node to a target IAB Donor-CU node. The IAB-MT remains connected to the source IAB Donor-CU via a F1 connection and establishes RRC connection with the target IAB Donor-CU node. Further, the method includes retaining, by the source IAB donor CU, a security context associated with the F1 connection of the IAB-MT based on the detection. Further, the method includes migrating, by the source IAB donor CU, the IAB-MT from the source IAB Donor-CU node to the target IAB Donor-CU node by establishing a secure RRC connection between the IAB-MT and the target IAB Donor-CU.

In an embodiment, a source IAB Donor-CU and the migrating IAB-node derives the KIAB (PSK) for re-establishment of secure F1 interface. When IAB-MT migrates from an old parent node to a new parent node, where old and new parent nodes are served by different IAB-donor-CUs, the source IAB donor CU should not delete old context. The source IAB donor CU derives KIAB PSK from KNG-RAN. The source IAB Donor-CU derives KIAB (PSK) using old KIAB PSK identified by gNB-DU ID for establishment of secure F1 interface between migrating IAB-node and target IAB donor CU. An old PSK is used to preserve the KgNB in case of topology adaptation. Assuming scenario where the source IAB-node DU was assigned with IP address1 and IP address2 before migration. The corresponding KIAB1 and KIAB2 respectively. After migration, the IAB-node DU is reconfigured with the IP address3 and IP address4, for which new KIAB3 and KIAB4 needs to be derived.

For IAB inter-CU topology adaptation procedures, new IKEv2 procedure between IAB-node and the IAB-donor-CU is performed using the dynamic PSK associated with the old IP address as the static PSK for the corresponding new IP address. If dynamic PSK computation for IKEv2 PSK authentication is used, then the IKEv2 between migrating IAB-node and the source IAB-donor-CU (214) is performed using stored KIAB as PSK.

In case IPsec tunnel mode is used for F1 interface protection, the migrating IAB-node may use MOBIKE (IETF RFC 4555) to migrate the IPsec tunnel to the new IP outer addresses. For IPsec transport mode, the gNB-DU ID provided in the IKE_AUTH message is used to identify the PSK(s), as like the identification performed for the certificate and pre-configured PSK authentication methods. Further, when there are more than one old/new IP addresses, the IKEv2 procedures are performed according to the TNL address index, as to have identical mapping between the old TNL address with the new TNL address in the source/Initial IAB-donor-CU and in the migrating/descendant/recovery IAB-node.

The proposed method can be used to ensure the security protection in migration scenario by performing new IKEv2 procedure between IAB-node and the IAB-donor-CU using the dynamic PSK associated with the old IP address as the static PSK for the corresponding new IP address.

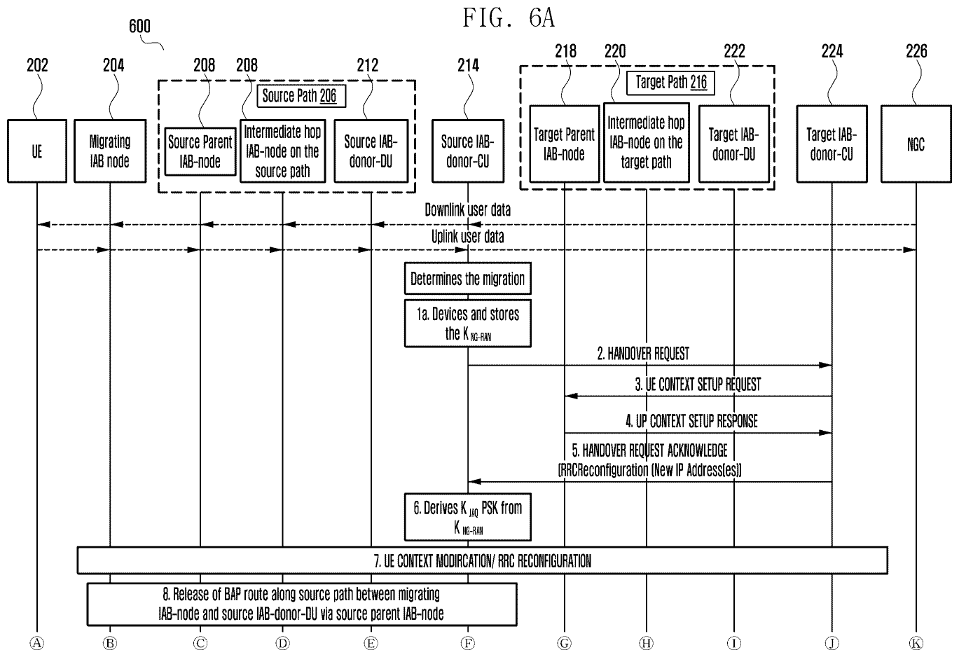

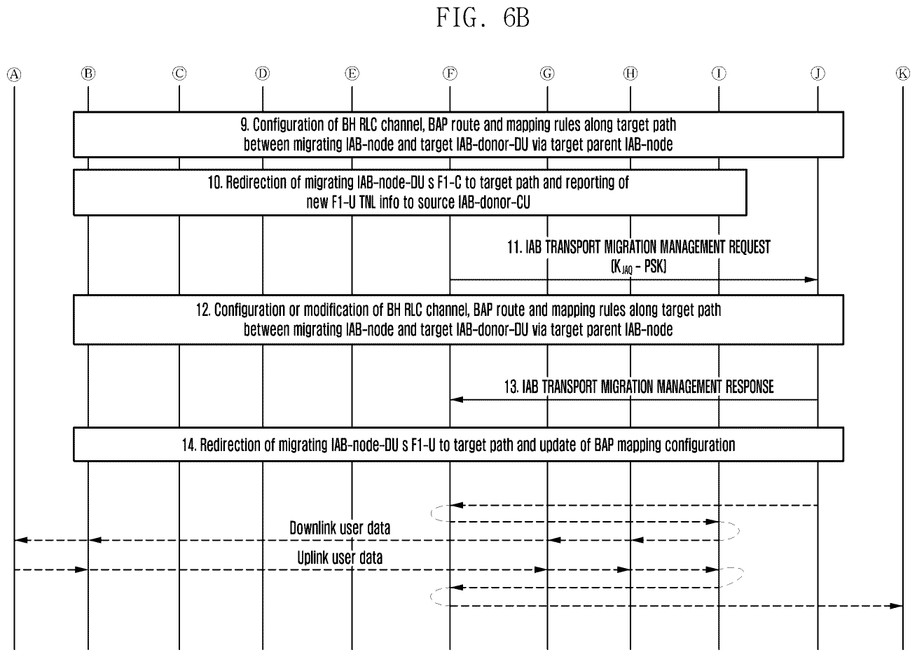

Referring now to the drawings and more particularly to FIGS. 6 through 8, where similar reference characters denote corresponding features consistently throughout the figure, these are shown preferred embodiments.

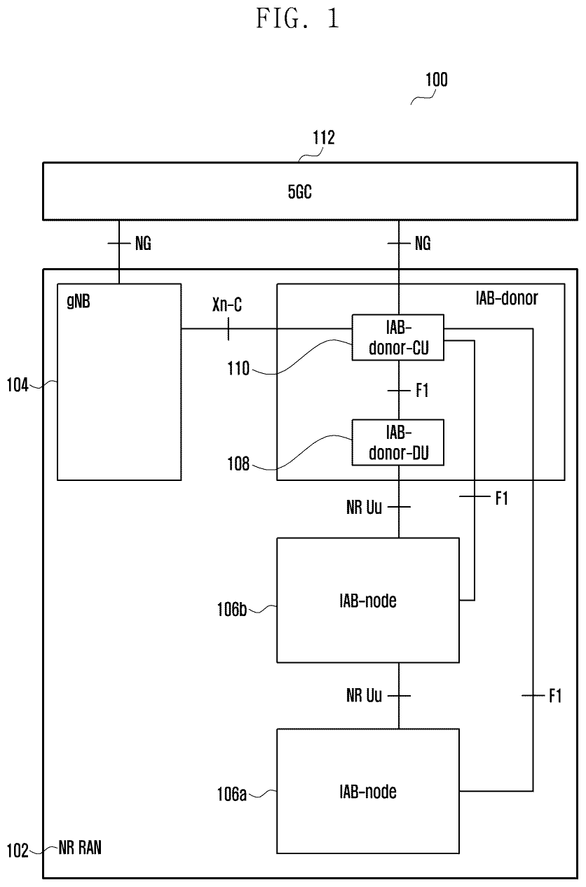

FIG. 1 illustrates a schematic of an Integrated Access and Backhaul (IAB) architecture (100), according to the prior art. In a telecommunication domain, a Next Generation Radio Access Network (NG-RAN) (102) is used as a part of a Third Generation Partnership Project (3GPP) fifth generation (5G) system. The NG-RAN (102) is responsible for providing Radio Access to 5G networks. The NG-RAN (102) supports an IAB. The IAB-node (106a and 106b) wirelessly connecting to a gNB (104) is capable of serving the IAB-nodes (106a and 106b), named IAB-donor. The IAB-donor consists of an IAB-donor-CU (110) and one or more IAB-donor-DU(s) (108) as shown in FIG. 1. In case of separation of gNB central unit control plane (gNB-CU-CP) and gNB central unit user plane (gNB-CU-UP), the IAB-donor may consist of an IAB-donor-CU-CP, multiple IAB-donor-CU-UPs and multiple IAB-donor-DUs (108). The IAB-node (106a and 106b) connects to an upstream IAB-node or an IAB-donor-DU (108) via a subset of User Equipment (UE) functionalities of a New Radio (NR) Uu interface (named IAB-MT function of IAB-node). The IAB-node (106a and 106b) provides wireless backhaul to the downstream IAB-nodes and UEs (202) via the network functionalities of the NR Uu interface (named IAB-DU function of IAB-node). The F1 interface (F1-C) traffic between the IAB-node (106a and 106b) and the IAB-donor-CU (110) is backhauled via the IAB-donor-DU (108) and the optional intermediate hop IAB-node(s). The F1-U traffic between an IAB-node (106a and 106b) and the IAB-donor-CU (110) is backhauled via the IAB-donor-DU (108) and the optional intermediate hop IAB-node(s).

During the inter-CU migration, the migrating IAB-MT establishes a new RRC connection with the target IAB-donor-CU and maintains the F1 connection with the source IAB-donor-CU. The target IAB-donor-CU assigns new IP address to the migrating IAB-node DU (108). The newly assigned IP address will be taken into use for the F1 connections between the migrating IAB-node DU (108) and source IAB-donor-CU. When dynamic PSK is used for establishment of secure F1 interface, the IAB-node and the IAB-donor shall compute the PSK (K_{IAB}) with K_{gNB} as input parameter. However, the K_{gNB} in IAB-node (106a and 106b) and Source IAB-donor are different after the migration, which results to the new PSK (K_{IAB}) mismatch between the migrating IAB-node DU (108) and source IAB-donor-CU. In addition, the newly assigned IP address need to be taken into account. The IKEv2 PSK authentication for the F1 connections during the migration will fail leading to out-of-service due to the mismatch of IP address.

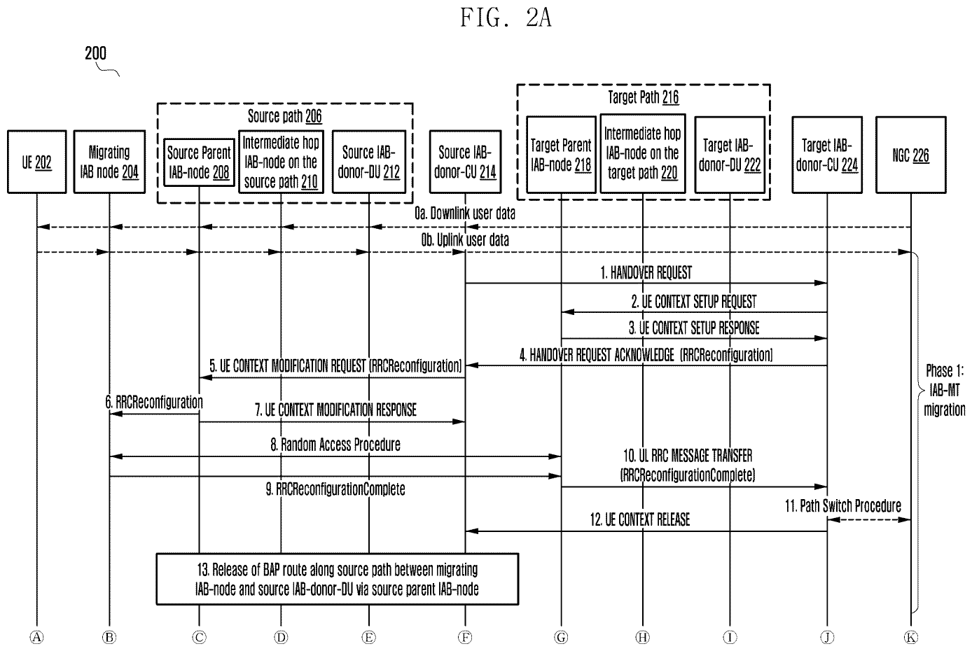

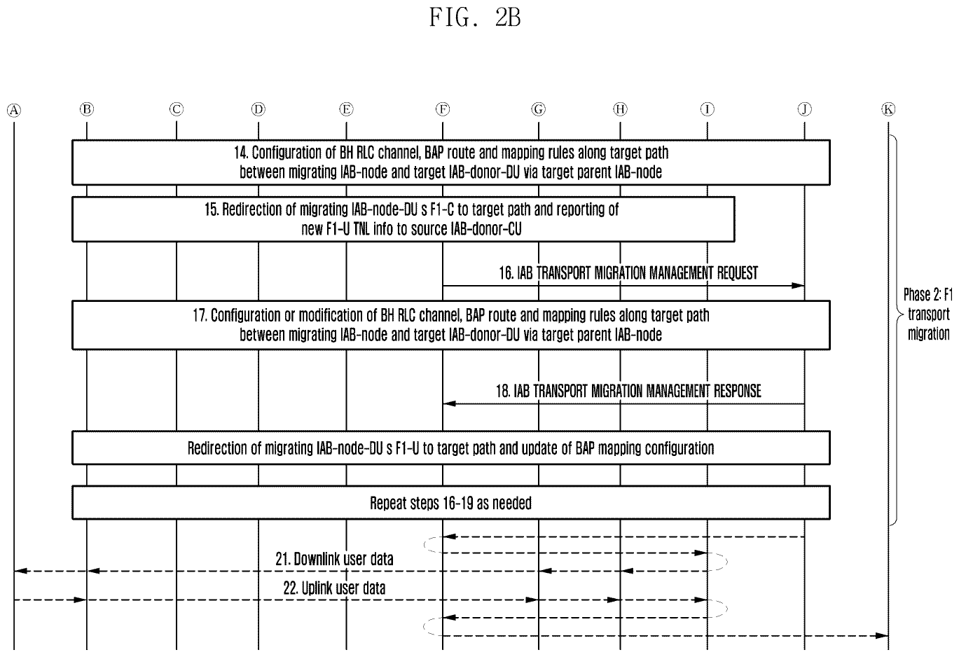

FIG. 2 illustrates a sequence diagram of IAB inter-CU topology adaptation procedure (200), according to the prior art. During the inter-CU topology adaptation for a single-connected IAB-node, the IAB-MT migrates from an old parent node to a new parent node, where the old and the new parent nodes are served by different IAB-donor-CUs. Without loss of generality, the old parent node is referred to as source parent node, and the new parent node is referred to as target parent node. In the topology adaptation procedure, where the IAB-MT is migrated from a source IAB-donor-CU (214) to a target IAB-donor-CU (224). In the procedure, the migrating IAB-node becomes a boundary IAB-node since its IAB-DU retains F1AP with the source IAB-donor-CU (214) while its IAB-MT obtains RRC connectivity with the target IAB-donor-CU (224).

The non-F1-terminating IAB-donor-CU can initiate the full revoking of traffic offload by executing the XnAP Handover Preparation procedure for the migrating IAB-MT. After the migrating IAB-MT is handed over in reverse direction, i.e., from the non-F1-terminating IAB-donor-CU to the F1-terminating IAB-donor-CU, the traffic of the migrating IAB-node's IAB-DU is routed again along the former source path (206). The F1-terminating IAB-donor-CU can initiate the full revoking of traffic offload by requesting the release of all offloaded traffic from the non-F1-terminating IAB-donor-CU by sending the IAB TRANSPORT MIGRATION MANAGEMENT REQUEST to the non-F1-terminating IAB-donor-CU. This message may trigger the XnAP Handover Preparation procedure for the migrating IAB-MT towards the F1-terminating IAB-donor-CU. The F1-terminating IAB-donor-CU may request full or partial release of the offloaded traffic from the non-F1-terminating IAB-donor-CU via the IAB TRANSPORT MIGRATION MANAGEMENT REQUEST message.

Initially, step 0a, the UE (202) receives the downlink user data from a Next Generation Core (NGC) (226) through the source IAB-donor-CU (214). At step, Ob, the UE (202) sends the uplink user data to the NGC (226) through the source IAB-donor-CU (214).

At step 1, the source IAB-donor-CU (214) sends a handover request to a target IAB-donor-CU (224). At step 2, the target IAB-donor-CU (224) sends a UE context setup request to a target parent IAB-node (218). At step 3, the target parent IAB-node (218) sends the UE context setup response to the target IAB-donor-CU (224) based on the UE context setup request. At step 4, the target IAB-donor-CU (224) sends a handover request acknowledge including the RRCReconfiguration to the source IAB-donor-CU.

At step 5, the source IAB-donor-CU sends the UE context modification request including the RRCReconfiguration to the source parent IAB-node (208). At step 6, the source parent IAB-node (208) sends the RRCReconfiguration to the migrating IAB node (204). At step 7, the source parent IAB-node (208) sends the UE context modification response to the source IAB-donor-CU. At step 8, a random access procedure is established between the target parent IAB-node (218) and the migrating IAB node (204). At step 9, the migrating IAB node (204) sends the RRCReconfigurationComplete to the target parent IAB-node (218).

At step 10, the target parent IAB-node (218) sends the UL RRC message transfer including the RRCReconfigurationComplete to the target IAB-donor-CU (224). At step 11, a path switch procedure is performed between the target IAB-donor-CU (224) and the NGC (226). At step 12, the target IAB-donor-CU (224) sends a UE context release to the source IAB-donor-CU. AT step 13, the release of BAP route is performed along the source path (206) between the migrating IAB-node and the source IAB-donor-DU (212) via the source parent IAB-node (208).

At step 14, the configuration of BH RLC channel, BAP route and mapping rules along target path (216) between the migrating IAB-node and the target IAB-donor-DU (222) is performed via the target parent IAB-node (218). At step 15, the migrating IAB-node-DUs F1-C is redirected to the target path (216) and new F1-U TNL information is reported to the source IAB-donor-CU (214).

At step 16, the source IAB-donor-CU sends an IAB transport migration management request to the target IAB-donor-CU (224). At step 17, the BH RLC channel and the BAP route is configured or modified and mapping rules along target path (216) is provided between the migrating IAB-node and the target IAB-donor-DU (222) via the target parent IAB-node (218). At step 18, the target IAB-donor-CU (224) sends the IAB transport migration management response to the source IAB-donor-CU. At step 19, migrating IAB-node-DU s F1-U is redirected to the target path (216) and BAP mapping configuration is updated. At step 20, the repeat steps 16-19 as needed. Based on the above operation, the UE (202) receives the downlink user data from NGC (226) via the source IAB-donor-CU (214) and the target IAB-donor-DU (222). Further, the UE (202) sends the uplink user data to the NGC (226) via the target IAB-donor-DU (222) and the source IAB-donor-CU (214).

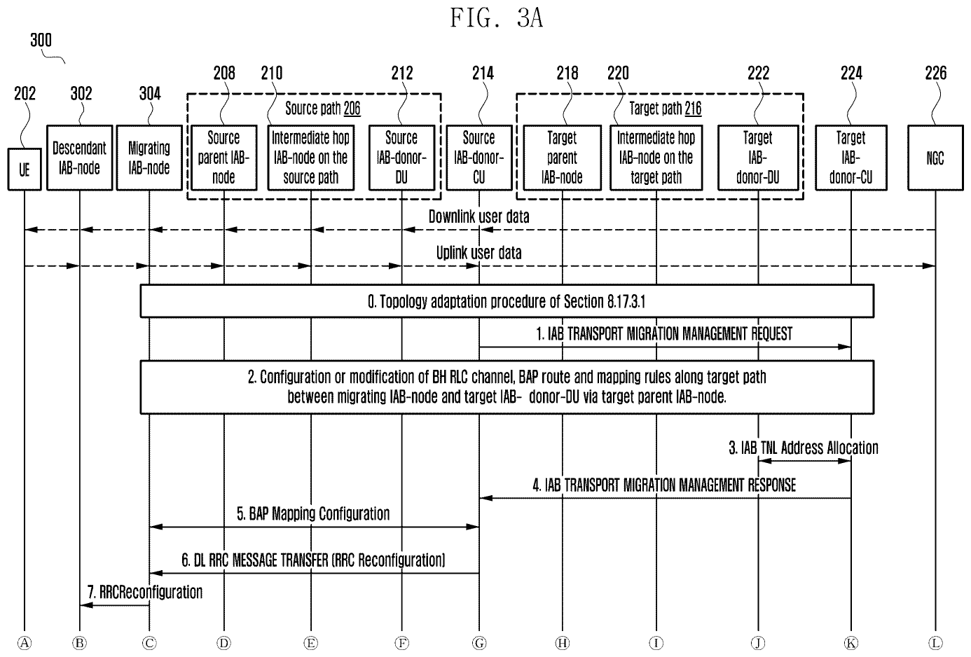

FIG. 3 illustrates a sequence diagram of an IAB inter-CU topology adaptation procedure (300) with the descendant IAB-node, according to the prior art. In other words, FIG. 3 shows a sequence diagram of a topology adaptation procedure where the migrating IAB-MT is migrated from the source IAB-donor-CU (214) to the target IAB-donor-CU (224). The migrating IAB-node has a descendant IAB-node which retains both its RRC connection and F1 connection with the source IAB-donor-CU (214).

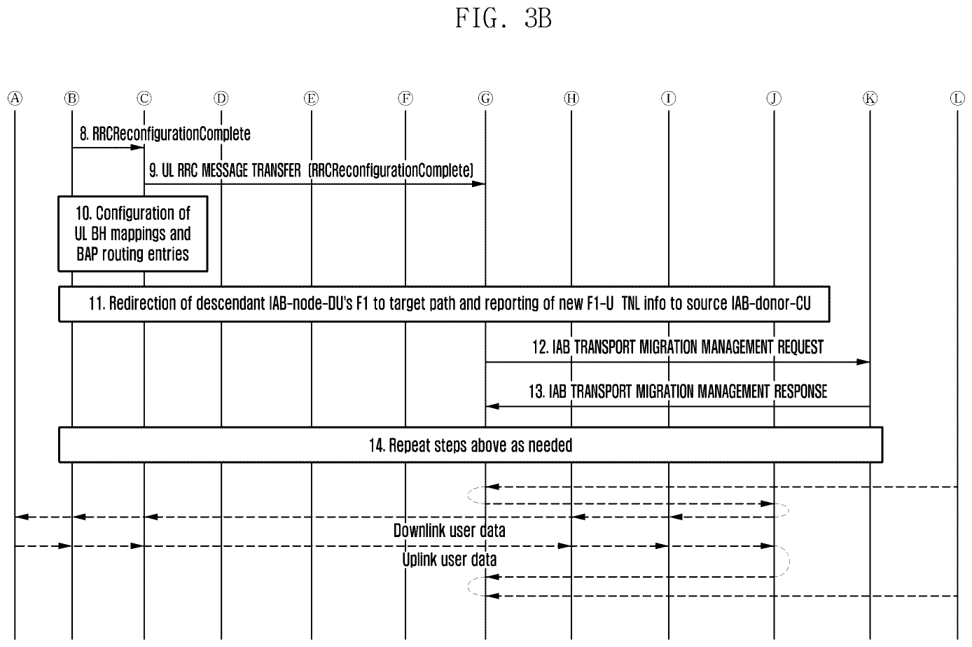

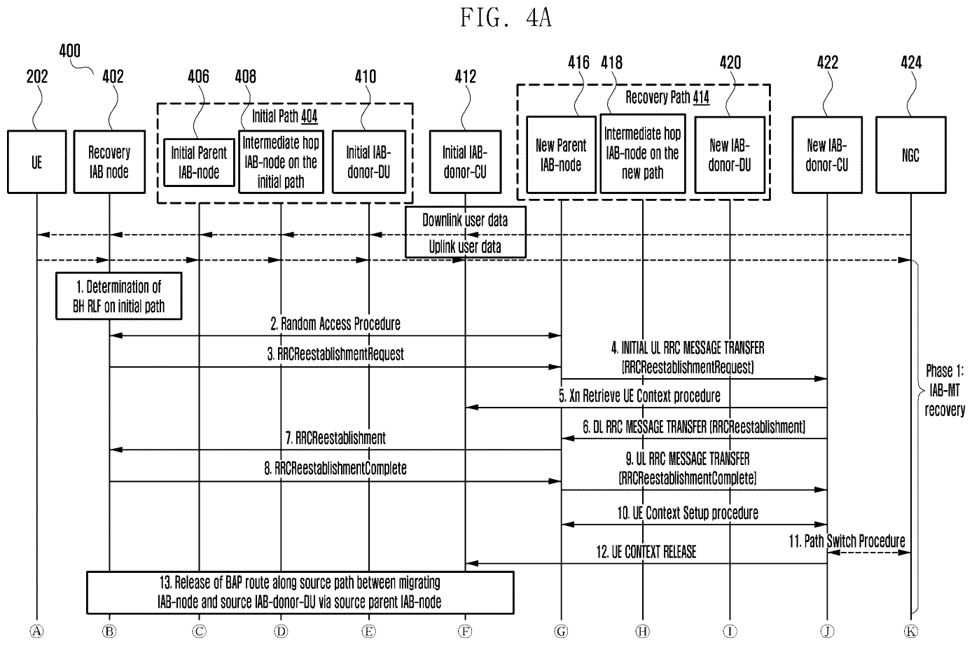

The inter-CU backhaul RLF recovery procedure for IAB-nodes in SA mode enables recovery of an IAB-node to another parent node underneath a different IAB-donor-CU, when the IAB-MT of the IAB-node detects backhaul RLF. FIG. 4 shows an example of the backhaul RLF recovery procedure for an IAB-node in SA mode. In this example, the IAB-node changes from its initial parent node to a new parent node, where the new parent node is served by a different IAB-donor-CU than that serving its initial parent node. In this procedure, the recovering IAB-node becomes a boundary IAB-node since the IAB-DU retains F1AP with the initial IAB-donor-CU while its IAB-MT obtains RRC connectivity with the new IAB-donor-CU.

Initially, step 0a, the UE (202) receives the downlink user data from the NGC (226) through the source IAB-donor-CU (214). At step Ob, the UE (202) sends the uplink user data to the NGC (226) through the source IAB-donor-CU (214). At step 1, the topology adaptation procedure is performed among the migrating IAB-node and the target IAB-donor-CU (224) as per the 3GPP section 8.17.3.1.

At step 2, the Source IAB-donor-CU sends the IAB transport migration management request to the target IAB-donor-CU (224). At step 3, the BH RLC channel and the BAP route are configured or modified and mapping rules along target path (216) is performed between the migrating IAB-node and the target IAB-donor-DU (222) via the target parent IAB-node (218). At step 4, the IAB TNL address allocation is performed between the target IAB-donor-DU (222) and the target IAB-donor-CU (224). At step 5, the target IAB-donor-CU (224) sends the IAB transport migration management response to the source IAB-donor-CU (214).

At step 6, BAP mapping configuration is performed between the migrating IAB-node and the source IAB-donor-CU (214). At step 7a, the source IAB-donor-CU (214) sends the DL RRC message transfer including the RRCReconfiguration to the migrating IAB-node. At step 7b, the migrating IAB-node sends the RRCReconfiguration to the descendant IAB-node. At step 8, the descendant IAB-node sends the RRCReconfigurationComplete to the migrating IAB-node.

At step 9, the migrating IAB-node sends the UL RRC message transfer including the RRCReconfigurationComplete to the source IAB-donor-CU (214). At step 10, the UL BH mappings and BAP routing entries are configurated between the descendant IAB-node and the migrating IAB-node. At step 11, redirection of descendant IAB-node-DU's F1 to the target path (216) is performed and the new F1-U TNL info is reported to the source IAB-donor-CU (214). At step 12, the source IAB-donor-CU (214) sends the IAB transport migration management request to the target IAB-donor-CU (224). At step 13, the target IAB-donor-CU (224) sends an IAB transport migration management response to the source IAB-donor-CU (214). At step 14, repeat steps above as needed. At step 15, the UE (202) receives the downlink user data from the NGC (226) via the source IAB-donor-CU (214) and the target IAB-donor-DU (222). At step 16, the UE (202) sends the uplink user data to the NGC (226) via the target IAB-donor-DU (222) and the source IAB-donor-CU (214).

FIG. 4 illustrates a sequence diagram of IAB inter-CU backhaul RLF recovery procedure (400) for an IAB-node in SA mode, according to the prior art. The IAB inter-CU topology adaptation procedure with descendant IAB-node. FIG. 4 shows an example of the topology adaptation procedure where the migrating IAB-MT is migrated from a source IAB-donor-CU (214) to a target IAB-donor-CU (224), and where the migrating IAB-node has a descendant IAB-node which retains both its RRC connection and F1 connection with the source IAB-donor-CU (214). The inter-CU backhaul RLF recovery procedure for IAB-nodes in SA mode enables recovery of an IAB-node to another parent node underneath a different IAB-donor-CU, when the IAB-MT of the IAB-node detects backhaul RLF. FIG. 4 shows an example of the backhaul RLF recovery procedure for an IAB-node in SA mode. In this example, the IAB-node changes from its initial parent node to a new parent node, where the new parent node is served by a different IAB-donor-CU than that serving its initial parent node. In this procedure, the recovering IAB-node becomes a boundary IAB-node since the IAB-DU retains F1AP with the initial IAB-donor-CU while its IAB-MT obtains RRC connectivity with the new IAB-donor-CU. During the inter-CU migration, the new IP address of the migrating IAB-node DU will be taken into use for the F1 connections between the migrating IAB-node DU and source IAB-donor-CU (214). When dynamic PSK is used for establishment of secure F1 interface, the IAB-node and the IAB-donor shall calculate the PSK (KIAB) with K_{gNB} as input parameter. However, the K_{gNB} in IAB-node and Source IAB-donor are different after the migration, which results to the new PSK (K_{IAB}) mismatch between the migrating IAB-node DU and source IAB-donor-CU (214). The IKEv2 PSK authentication for the F1 connections during the migration will fail.

Initially, step 0a, the UE (202) receives the downlink user data from the NGC (226) through the initial IAB-donor-CU. At step Ob, the UE (202) sends the uplink user data to the NGC (226) through the initial IAB-donor-CU.

At step 1, the recovery IAB node (402) determines the BH RLF on the initial path. At step 2, the random access procedure is done between the new parent IAB-node (406) and the recovery IAB node (402). At step 3, the recovery IAB node (402) sends the RRCReestablishmentRequest to the new parent IAB-node (406).

At step 4, the new parent IAB-node (406) sends the initial UL RRC message transfer including the RRCReestablishment request to the new IAB-donor-CU (420). At step 5, an Xn Retrieve UE context procedure is established between the new IAB-donor-CU (420) and the initial IAB-donor-CU (410). At step 6, the new parent IAB-node (406) sends the DL RRC message transfer including the RRCReestablishment to the new Parent IAB-node (406).

At step 7, the new parent IAB-node (406) sends the RRCReestablishment to the recovery IAB node (402). At step 8, the recovery IAB node (402) sends the RRCReestablishmentComplete to the new parent IAB-node (406). At step 9, the new parent IAB-node (406) sends the UL RRC message transfer including the RRCReestablishmentComplete to the new IAB-donor-CU (422).

At step 10, the UE context setup procedure is established between the new parent IAB-node (406) and the new IAB-donor-CU (422). At step 11, the path switch procedure is performed between the new IAB-donor-CU and the NGC (226). At step 12, the new IAB-donor-CU (420) sends the UE context release to the initial IAB-donor-CU. At step 13, BAP route along source path (206) is released between the migrating IAB-node and the source IAB-donor-DU (212) via the source parent IAB-node (208).

At step 14, the new IAB-donor-CU (422) sends the DL RRC message transfer including the RRCReconfiguration to the new parent IAB-node (406). At step 15, the new parent IAB-node (406) sends the RRCReconfiguration to the recovery IAB node (402). At step 16, the recovery IAB node (402) sends the RRCReconfigurationComplete to the new parent IAB-node (406). At step 17, the new parent IAB-node (406) sends the UL RRC message transfer including the RRCReconfigurationComplete to the new IAB-donor-CU. At step 18, same as steps 11-17 of inter-CU topology adaptation procedure.

At step 19, the UE (202) receives the downlink user data from the NGC (226) via the initial IAB-donor-CU and the new IAB-donor-CU. At step 20, the UE (202) sends the uplink user data to the NGC (226) via the new IAB-donor-CU and the initial IAB-donor-CU.

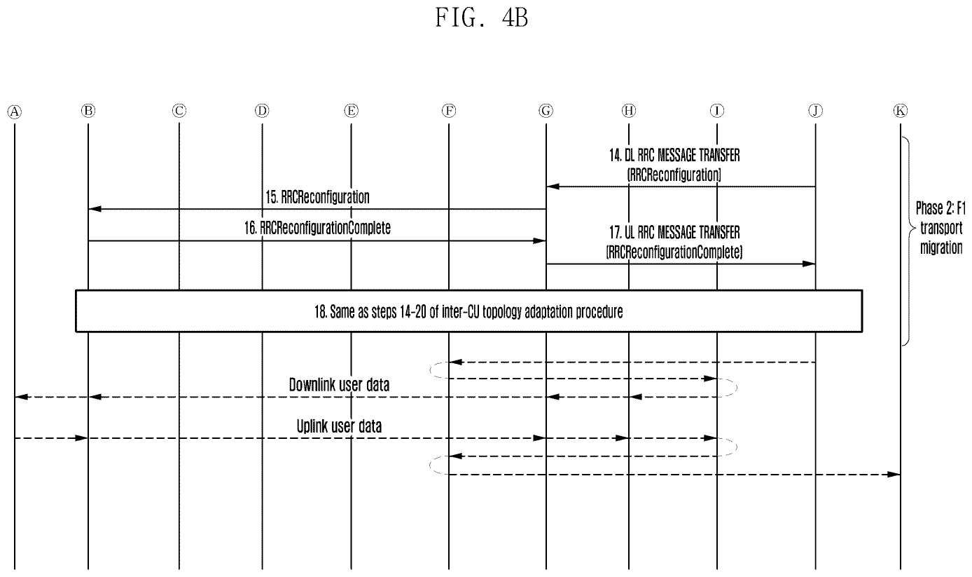

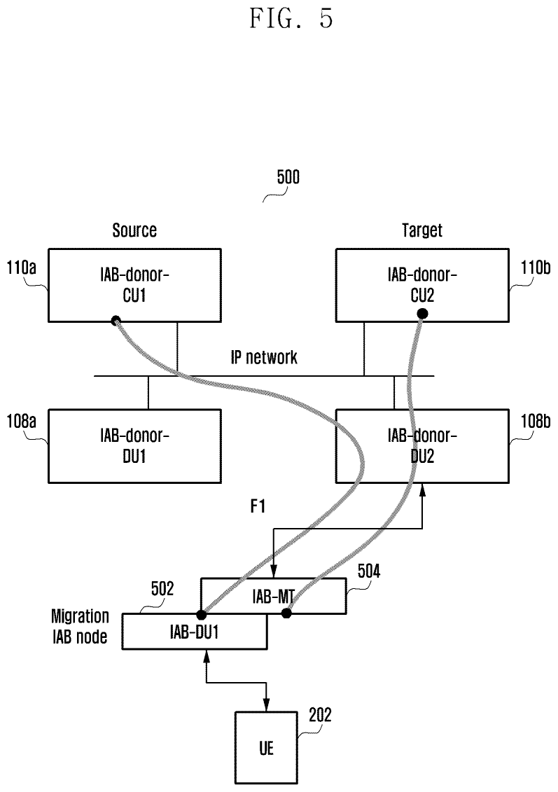

FIG. 5 illustrates a schematic of IAB migration procedure (500), according to the prior art. During the inter-CU migration, the new IP address of the migrating IAB-node DU (108a, 108b) will be taken into use for the F1 connections between the migrating IAB-node DU (108a, 108b) and source IAB-donor-CU (214). When dynamic PSK is used for establishment of secure F1 interface, the IAB-node and the IAB-donor shall calculate the PSK (KIAB) with KgNB as input parameter. However, the KgNB in IAB-node and Source IAB-donor are different after the migration, which results to the new PSK (KIAB) mismatch between the migrating IAB-node DU (108a, 108b) and source IAB-donor-CU (214). The IKEv2 PSK authentication for the F1 connections during the migration will fail. In other words, the Boundary IAB-node (an IAB-node with one RRC interface terminating at a different IAB-donor-CU than the F1 interface) has the issue as there is no means to generate the PSK (K_{IAB}), when the IP address of the IAB node (106a, 106b, 204) changes and RRC/AS security context is deleted (due to migration of the IAB node (106a, 106b, 204) from source to target IAB-donor-CU (224) for the IAB Inter-CU Topology Management scenarios IAB Inter-CU Topology Adaptation, IAB Inter-CU Backhaul RLF recovery for single connected IAB-node, like so). As the PSK is derived from the AS security context key KgNB and IP addresses of the IAB node (106a, 106b, 204) and the IAB-donor-CU, if the IP address changes then to generate new PSK to re-establish the F1 interface, there needs a method. If there is no method to derive the PSK, then the F1 interface re-establishment procedure that includes IKEv2 procedure will fail, as the authentication key PSK is not available with the source IAB-donor-CU (214), results in IAB node (106a, 106b, 204) in Out-of-service.

FIG. 6 illustrates a sequence diagram of PSK derivation from K_{NG RAN}* during IAB migration in a wireless network (600), according to the embodiments as disclosed in herein. The source IAB donor CU (214) derives the K_{IAB} PSK from the KING RAN* specific to the target and the IAB-node DU IP address assigned by the target IAB node (204).

The source-gNB derives the K_{IAB} PSK from the K_{NG RAN}*. In an embodiment, the source IAB Donor-CU (214) derives the K_{IAB} (PSK) for re-establishment of secure F1 interface between the migrating IAB-node (204) and the source IAB donor CU (214). In an embodiment, when the IAB-MT migrates from an old parent node to a new parent node, where the old and the new parent nodes are served by different IAB-donor-CUs, the source IAB donor CU (214) should not delete the security context of the migrating IAB-node (204). The source IAB donor CU (214) derives the K_{IAB} PSK from the K_{NG RAN}* and stores it in the security context. Similarly. The migrating IAB-node (204) also maintains two security context/association, one with the source IAB donor CU (214) and another with the target IAB donor CU (224). During the migration procedure, the IAB node (204) updates the security context of the source IAB donor CU (214) with the derived K_{IAB} (PSK) based on the key K_{NG RAN}* and the assigned IAB Node DU IP address. Detailed procedure is as follows:

Initially, step 0a, the UE (202) receives the downlink user data from the NGC (226) through the source IAB-donor-CU (214). At step Ob, the UE (202) sends the uplink user data to the NGC (226) through the source IAB-donor-CU (214).

At step 1 and step 1a, the source IAB donor CU (214) determines the IAB node migration and derives the K_{NG RAN*} and stores the same. At step 2, the source IAB-donor-CU (214) sends an Xn HANDOVER REQUEST message to the target IAB-donor-CU (224). The message may include the migrating IAB-node's TNL address information in the RRC container.

At step 3-step 4, the target IAB-donor-CU (224) creates the UE context for the migrating IAB-MT and to set up the bearers, which the migrating IAB-MT uses for its signalling, and, optionally, data traffic.

At step 5, the target IAB-donor-CU (224) provides the new RRC reconfiguration as part of the handover request acknowledge message. The RRC configuration includes the new (outer) IP addresses and corresponding new (inner) IP address. The source IAB donor CU (214) obtains the IAB-node DU IP address from the handover request acknowledge message for deriving the K_{IAB} (PSK) for the re-establishment of secure F1 interface between migrating IAB-node and source IAB donor CU.

At step 6, the source IAB donor CU (214) derives the K_{IAB}-PSK from K_{NG RAN*} as follows:

K_{IAB} generation function: This input string is used when the migrating IAB-node and the source IAB-donor CU (214) derive K_{IAB} (PSK) for establishment of secure F1 interface over target path (216) during migration. The following parameters is used to form the input S to the KDF:

$$FC = 0 xxxx ,$$

$$P 0 = Source IAB - donor - CU IP address ,$$

$$L 0 = length of Source IAB - donor - CU IP address ,$$

$$P 1 = IAB - node DU IP address ,$$

$$L 1 = length of IAB - node DU IP address .$$

The input key shall be K_{NG RAN*} if the key K is in possession of the IAB-UE functionality in the migrating IAB-node (204) and in the source IAB-donor-CU (214). Step 6 may be performed after Step 10 (not immediately after Step 5). If K_{IAB} generation is performed after the step 10, then the source IAB-donor-CU (214) use the TNL IP address(es) provided by the migrating IAB-DU (502) in an F1AP gNB-DU Configuration Update message for PSK generation.

In another embodiment, the input S to the KDF can be at least one of Source IAB donor CU IP address, Target IAB donor CU IP address, IAB node DU IP address, Source IAB node DU IP address.

At step 7-10, the source parent node IAB-DU (502) responds to the source IAB-donor-CU (214) with the UE context modification. The source IAB-donor-CU (214) may release BH RLC channels. The target IAB-donor-CU (224) configures BH RLC channels and BAP-sublayer routing entries on the target path (216) between the migrating IAB-node and target IAB-donor-DU (222), as well as DL mappings on the target IAB-donor-DU (222) for the migrating IAB-node's target path (216). The F1-C connection between the migrating IAB-node and the source IAB-donor-CU (214) are switched to the target path (216) using the new TNL address information of the migrating IAB-node.

If the migrating IAB-node uses MOBIKE (IETF RFC 4555) to migrate the IPsec tunnel to the new IP outer addresses. After the completion of the MOBIKE procedure, the migrating IAB-DU (502) initiates an F1AP gNB-DU Configuration Update procedure from which the IAB-donor-CU can conclude whether the existing inner IP address(es) (e.g., for SCTP association) and the DL F-TEID can be reused.

If new TNL addresses for F1-C traffic are configured, new SCTP association(s) between the migrating IAB-node and the F1-terminating IAB-donor-CU may be established using the new TNL address information of the migrating IAB-node. The migrating IAB-node sends an F1AP gNB-DU CONFIGURATION UPDATE message to the F1-terminating IAB-donor-CU, which may include new (outer) IP addresses and corresponding new (inner) IP address for the F1-U traffic to be switched to the target path (216).

At step 11-14, the source IAB-donor-CU (214) sends an IAB TRANSPORT MIGRATION MANAGEMENT REQUEST message to the target IAB-donor-CU (224), to provide the context of the traffic to be offloaded. The target IAB-donor-CU (224) sends the source IAB-donor-CU (214) an IAB Transport Migration Management Response message (as per current state of art, in FIG. 3), to provide the mapping information for the traffic to be offloaded. The message should also include the new (outer) IP addresses and corresponding new (inner) IP address for the F1-U traffic to be switched to the target path (216).

Alternative 2: Source-gNB derives the K_{IAB} PSK from the old K_{IAB} PSK: In an embodiment, the source IAB Donor-CU and IAB node derives the fresh K_{IAB} (PSK) using the old K_{IAB} PSK identified by the gNB-DU ID and/or PSK ID as the KEY parameter for establishment of secure F1 interface between migrating IAB-node and target IAB donor CU.

K_{IAB} generation function: This input string is used when the migrating IAB-node and the source IAB-donor CU derive K_{IAB} (PSK) for establishment of secure F1 interface over target path (216) during migration. The following parameters is used to form the input S to the KDF:

$$FC = 0 xxxx ,$$

$$P 0 = Source IAB - donor - CU IP address ,$$

$$L 0 = length of Source IAB - donor - CU IP address ,$$

$$P 1 = IAB - node DU IP address ,$$

$$L 1 = length of IAB - node DU IP address .$$

The input key KEY shall be old K_{IAB}, if the key K is in possession of the IAB-UE functionality in the migrating IAB-node and in the source/target IAB-donor-CU (224).

In an embodiment if more than one K_{IAB} PSK is available at the source IAB donor CU and the IAB node (204), then XOR operation is performed to get a root K_{IAB} PSK which is used further as the KEY to derive the new K_{IAB} PSK. Suppose KIAB1, KIAB2, KIAB3 is available then K_{IAB1} (XOR) K_{IAB2} (XOR) K_{IAB3}=root PSK.

Assuming the scenario where Source IAB-node DU was assigned with IP address 1 and IP address 2 before migration. The corresponding K_{IAB1} and K_{IAB2} respectively. After migration, the IAB-node DU is reconfigured with IP address 3 and IP address 4, for which the new K_{IAB3} and K_{IAB4} needs to be derived. The PSKs are derived as follows:

$${K}_{IAB 1} ( XOR ) {K}_{IAB 2} = root PSK . \qquad Option 1$$

$${K}_{IAB 1} \vert \vert {K}_{IAB 2} = root PSK \\ {K}_{IAB 3 / 4} generation function \qquad Option 2$$

This input string is used when the migrating IAB-node and the source IAB-donor CU derive K_{IAB3/4} (PSK) for establishment of secure F1 interface over target path (216) during migration. The following parameters is used to form the input S to the KDF:

$$FC = 0 xxxx ,$$

$$P 0 = Source IAB - donor - CU IP address ,$$

$$L 0 = length of Source IAB - donor - CU IP address ,$$

$$P 1 = IAB - node DU IP address , and$$

$$L 1 = length of IAB - node DU IP address .$$

The input key KEY shall be root PSK if the key K is in possession of the IAB-UE functionality in the migrating IAB-node and in the source/target IAB-donor-CU (224). The IP addresses used as input S is IP address 3 and IP address 4 for the PSKs respectively.

Alternative 3: Mapping of the old and new TNL IP addresses with the associated PSK: In another embodiment, PSK is preserved and associated IP addresses are mapped in case of topology adaptation (and/or for the Boundary IAB-node). Assuming the scenario where Source IAB-node DU was assigned with IP address 1 and IP address 2 before migration. The corresponding K_{IAB1} and K_{IAB2} respectively. After migration, the IAB-node DU is reconfigured with IP address 3 and IP address 4, for which the new K_{IAB3} and K_{IAB4} needs to be derived. The PSKs are mapped to the IP addresses as follows:

In an embodiment, the IP addresses prior to migration IP address 1 and IP address 2 are mapped to the IP address 3 and IP address 4 in ascending order or alternatively in descending order. For illustrative purpose, if the old and new IP addresses are ordered in ascending, then the PSK associated with IP address 1 is used for IP address 3 and PSK associated with IP address 2 is used for IP address 4.

In an embodiment, the mapping of the old IP address with the new IP address is provided by the migrating IAB-node in an F1AP gNB-DU CONFIGURATION UPDATE message to the IAB-donor-CU. The IAB-DU (502) initiates an F1AP gNB-DU Configuration Update procedure, which may include new IP addresses and corresponding old IP address for the F1 traffic for the source IAB-donor-CU (214) to determine the mapping and to associate the corresponding PSK. By doing so, the association of the new IP address with the existing PSK is inline in both the IAB node (204) and also in the IAB-donor-CU.

Alternative 4: Preserving the K_{gNB} by the IAB node and the IAB-donor-CU: In an embodiment, the IAB node (204) and the IAB-donor-CU preserve the K_{gNB} without deletion, as long as the F1 is not terminated, even though there is no RRC connection. When IAB-donor-CU determines that the IAB-MT is migrated to a target IAB-donor-CU (224), the source IAB-donor-CU (214) preserve the K_{gNB}. In an embodiment, the IAB-donor-CU preserves the K_{gNB} by storing the K_{gNB} in the F1 security context of the IAB Node (204). In an embodiment, the IAB-donor-CU preserves the K_{gNB} by moving the K_{gNB} from the AS security context of the IAB node (204) to the F1 security context of the IAB node (204). Further the IAB-donor-CU includes an indication (and may also include the NCC value) to the IAB node (204) to preserve the K gNB (which in use or identified by the NCC) in a RRC message, for illustrative purpose the RRC message being RRC reconfiguration message, so the IAB node (204) preserve the K_{gNB}. In an embodiment, the IAB node (204) preserves the K_{gNB} by storing the K_{gNB} in the F1 security context of the IAB-donor-CU. In an embodiment, the IAB node (204) preserves the K_{gNB} by moving the K_{gNB} from the AS security context of the IAB-donor-CU to the F1 security context of the IAB-donor-CU. Then when the F1 is re-established between the IAB node (204) and the source IAB-donor-CU (214), the preserved K_{gNB} in the F1 security context is used along with the IP addresses of the IAB node (204) and the IAB-donor-CU for generation of the new PSK at the IAB node (204) and the source IAB-donor-CU (214).

In an embodiment, the IAB node (204) and the source IAB-donor-CU (214) generates and preserve a new KNG-RAN* using the current KgNB, physical cell ID of the source IAB-donor-CU (214) and ARFCN-DL (physical cell downlink frequency) source IAB-donor-CU (214) for the purpose of PSK generation, when IAB node (204) migrates.

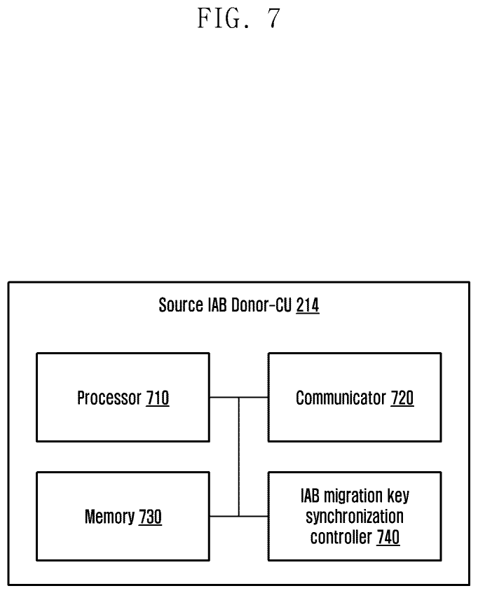

FIG. 7 shows various hardware components of the source IAB Donor CU (214), according to the embodiments as disclosed herein. In an embodiment, the source IAB Donor CU (214) includes a processor (710), a communicator (720), a memory (730) and an IAB migration key synchronization controller (740). The processor (710) is coupled with the communicator (720), the memory (730) and the IAB migration key synchronization controller (740).

The IAB migration key synchronization controller (740) detects the migration of the IAB-MT (504) from the source IAB Donor-CU (214) to the target IAB Donor-CU (224). The IAB-MT (504) remains connected to the source IAB Donor-CU (214) via the F1 connection and establishes the RRC connection with the target IAB Donor-CU (224). Based on the detection, the IAB migration key synchronization controller (740) retains the security context associated with the F1 connection of the IAB-MT (504). Further, the IAB migration key synchronization controller (740) migrates the IAB-MT (504) from the source IAB Donor-CU (214) to the target IAB Donor-CU node (224) by establishing the secure RRC connection between the IAB-MT (504) and the target IAB Donor-CU (224).

The IAB migration key synchronization controller (740) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (710) is configured to execute instructions stored in the memory (730) and to perform various processes. The communicator (720) is configured for communicating internally between internal hardware components and with external devices via one or more networks. The memory (730) also stores instructions to be executed by the processor (710). The memory (730) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (730) may, in some examples, be considered a non-transitory storage medium. The term “non-transitory” may indicate that the storage medium is not embodied in a carrier wave or a propagated signal. However, the term “non-transitory” should not be interpreted that the memory (730) is non-movable. In certain examples, a non-transitory storage medium may store data that can, over time, change (e.g., in Random Access Memory (RAM) or cache).

Although the FIG. 7 shows various hardware components of the source IAB Donor CU (214) but it is to be understood that other embodiments are not limited thereon. In other embodiments, the source IAB Donor CU (214) may include less or more number of components. Further, the labels or names of the components are used only for illustrative purpose and does not limit the scope of the invention. One or more components can be combined together to perform same or substantially similar function in the source IAB Donor CU (214).

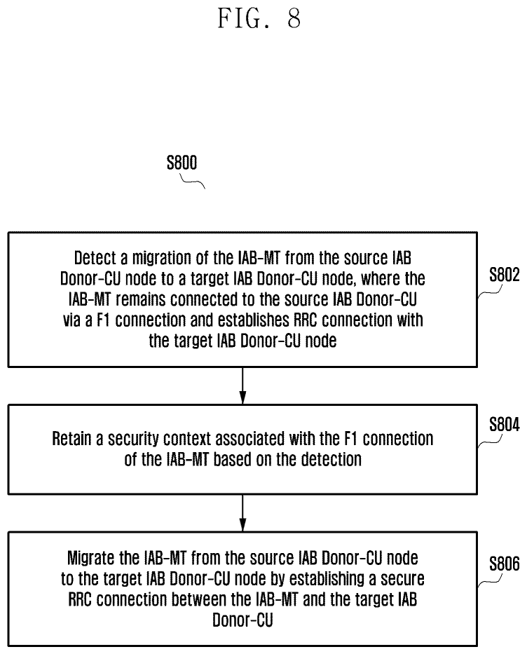

FIG. 8 is a flow chart (S800) illustrating a method for key synchronization for IAB migration in the wireless network (600), according to the embodiments as disclosed herein. The operations (S802-S806) are performed by the IAB migration key synchronization controller (740).

At S802, the method includes detecting the migration of the IAB-MT (504) from the source IAB Donor-CU (214) to the target IAB Donor-CU (224). The IAB-MT (504) remains connected to the source IAB Donor-CU via the F1 connection and establishes the RRC connection with the target IAB Donor-CU (224). At S804, the method includes retaining the security context associated with the F1 connection of the IAB-MT (504) based on the detection. At S806, the method includes migrating the IAB-MT (504) from the source IAB Donor-CU (214) to the target IAB Donor-CU (224) by cs-tablishing the secure RRC connection between the IAB-MT (504) and the target IAB Donor-CU.

Based on the proposed method, for the IAB inter-CU topology adaptation procedures, new IKEv2 procedure between the IAB-node and the IAB-donor-CU is performed using the dynamic PSK associated with the old IP address as the static PSK for the corresponding new IP address. If the dynamic PSK computation for IKEv2 PSK authentication is used, then the IKEv2 between migrating IAB-node and the source IAB-donor-CU (214) is performed using stored KIAB as PSK.

In case IPsec tunnel mode is used for F1 interface protection, the migrating IAB-node may use MOBIKE (IETF RFC 4555) to migrate the IPsec tunnel to the new IP addresses. For IPsec transport mode, the gNB-DU ID provided in the IKE_AUTH message is used to identify the PSK(s), as like the identification performed for the certificate and pre-configured PSK authentication methods. Further, when there are more than one old/new IP addresses, the IKEv2 procedures are performed according to the TNL address index, as to have identical mapping between the old TNL address with the new TNL address in the source/Initial IAB-donor-CU and in the migrating/dc-scendant/recovery IAB-node.

The proposed method can be used to ensure the security protection in migration scenario by performing new IKEv2 procedure between IAB-node and the IAB-donor-CU using the dynamic PSK associated with the old IP address as the static PSK for the corresponding new IP address.

The various actions, acts, blocks, steps, or the like in the flow chart (S800) may be performed in the order presented, in a different order or simultaneously. Further, in some embodiments, some of the actions, acts, blocks, steps, or the like may be omitted, added, modified, skipped, or the like without departing from the scope of the invention.

In general, Fifth Generation Multi-Operator Core Network (5G MOCN) sharing architecture, for sharing a Radio Access Network (RAN) to 5G System, is supported. The 5G MOCN includes a User Equipment (UE), a Radio Access Network (RAN) and an Access and Mobility Management Function (AMF) entity. The 5G MOCN for a 5G System supports operators ability to use more than one public land mobile network identifier (PLMN ID) (i.e. with same or different Mobile Country Code (MCC) some of which is specified in technical specification (TS) 23.122 and different Mobile Network Codes (MNC)) or combinations of PLMN ID and Network Identifier (NID). The 5G MOCN supports a Next Generation Radio Access Network (NG-RAN) sharing with or without multiple cell identity broadcast as described in TS 38.300. The 5G MOCN also supports the following sharing scenarios involving non-public networks. That is, the NG-RAN can be shared by any combination of PLMNs, public network integrated non-private networks (PNI-NPN) (with Closed Access Group (CAG)), and Stand-alone Non-Public Network (SNPN) (each identified by PLMN ID and NID).

In a key update procedure in the MBS session, when there is a need for key update (for example., expiry of MBS Traffic Key (MTK)), an Multicast/Broadcast Service Function (MBSF) triggers the key update procedure towards a Multicast/Broadcast Service Transport Function (MBSTF). For the MOCN, an Application Function (AF) apparatus generates and provides the MTK to the MBSF. However, when there is a need for the key update, it is not clear how the AF apparatus determines the key update requirement. In other words, how to handle the MTK update request from the MBSF and the MBSTF/MBSMF in case of MOCN needs further investigation. Currently, if the AF apparatus is the entity responsible for generating and distributing the MTK in the MOCN scenario. But, it is not clear how the AF apparatus is aware whether the PLMN supports a MOCN capability. In such cases, how the generated keys are distributed needs further investigation.

Consider a scenario where say PLMN1 supports the MOCN and is Multicast Broadcast Services (MBS) capable and say PLMN2 is MBS capable and does not support the MOCN. In such scenario, how the keys are distributed needs further investigation.

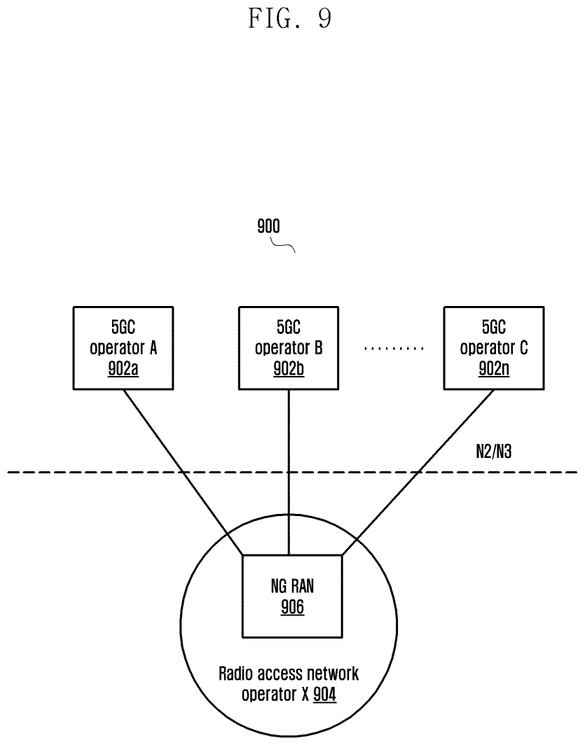

FIG. 9 illustrates a 5G MOCN (900) in which multiple CNs (902a-902n) are connected to the same NG-RAN (906). The multiple CNs are handled by different 5GC operator(s) (902a-902n). The AF apparatus (not shown) will set up multiple broadcast MBS sessions towards those CNs when a same broadcast content is to be delivered to the multiple CNs. Each CN delivering the same content towards the same-shared NG-RAN node (906) for their subscribers (User Equipment camped on the NG RAN (906); not shown). The same-shared NG-RAN node (906) is handled by the Radio access network operator (904). Therefore, for a broadcast MBS session, the consumed radio resource will be (N-1) times more than needed, where N is the number of CNs involved.

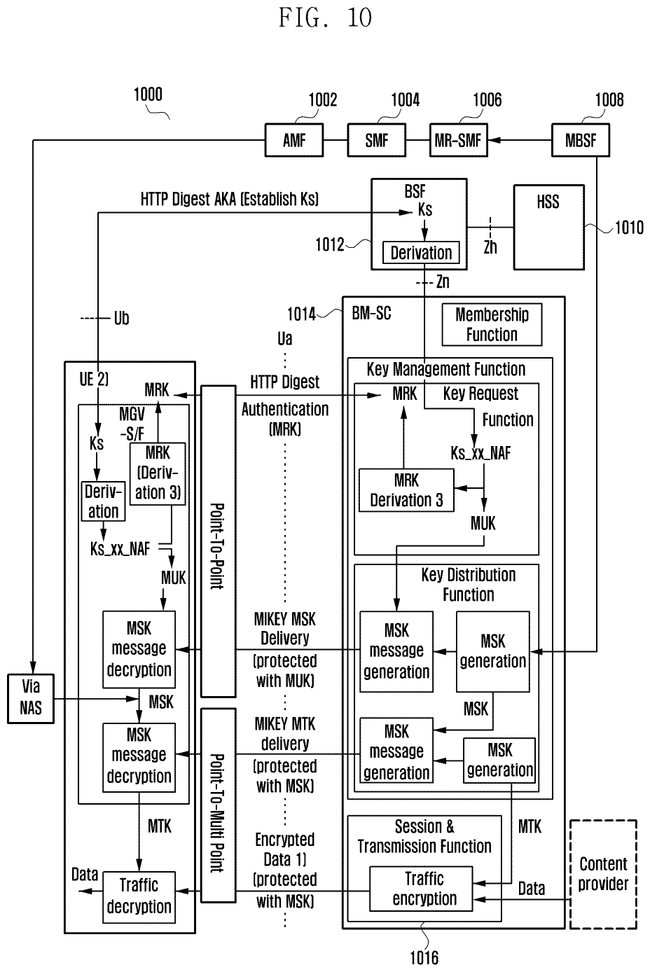

FIG. 10 shows a schematic diagram (1000) illustrating a method for performing key generation and key distribution in both control plane and user plane when the network is not shared (non-MOCN deployment scenario), according to the prior arts. The archi-tectural enhancements to the 5G system using NR to support multicast and broadcast communication services includes a AMF (1002), a Session Management Function (SMF) (1004), a Multicast/Broadcast Session Management Function (MB-SMF) (1006), a Multicast/Broadcast Service Function (MBSF) (1008), a Home Subscriber Server (HSS) (1010), a Bootstrapping Server Function (BSF) (1012), a Broadcast Multicast Service Centre (BM-SC) (1014), and a session and transmission function (1016). The AMF (1002), the SMF (1004), the MB-SMF (1006), the MBSF (1008), the HSS (1010), the BSF (1012), the BM-SC (1014), and the session and transmission function (1016) communicate with each other.

Referring to FIG. 10, the MBSF (1008) triggers the key update procedure towards the MBSTF when there is a need for key update (for example., expiry of MTK). For the MOCN scenario, the AF apparatus generates and provides the MTK to the MBSF (1008), when there is a need for key update. But, it is not clear how the AF apparatus determines the key update requirement. In other words, the MTK update request is handled from the MBSF (1008) and MBSTF/MBSMF in case of the no network sharing scenario. The PLMN1 supports the MOCN and is MBS capable and the PLMN2 is MBS capable and does not support the MOCN.

FIG. 11 shows a schematic diagram (1100) of a method for performing MTK generation and distribution for a MOCN deployment scenario, according to the prior arts.

At step 1, a Nnef_MBSSession_Create Request including a MBS Session ID, a service type, a QoS request, and security data is provided between the NEFs/MBSFs (1008a) in the PLMN 1 (1106a) and the NEFs/MBSFs in the PLMN2 (1106b).

At step 2, the NEFs/MBSFs (1008a) in the PLMN 1 (1106a) sends a Nmbsmf_MBSSession_Create request including the MBS Session ID, the service type, and the security data to the MB-SMF (1006a). Similarly, the NEFs/MBSFs (1008b) in the PLMN 1 (1106b) sends a Nmbsmf_MBSSession_Create Request including the MBS Session ID, the service type, and the security data to the MB-SMF (1006b).

At step 3, MB-SMF (1006a) sends a Nmbsmf_MBSSession_Create Response including the ingress address to the NEFs/MBSFs (1008a) in the PLMN 1 (1106a). Similarly, the MB-SMF (1006b) sends a Nmbsmf_MBSSession_Create Response including the ingress address to the NEFs/MBSFs (1008b) in the PLMN 1 (1106b).

At step 4, the NEFs/MBSFs (1008a) in the PLMN 1 (1106a) sends a session request including the ingress address and the security data to the MBSTF (1102a). Similarly, the NEFs/MBSFs (1008b) in the PLMN 1 (1106b) sends a session request including the ingress address and the security data to the MBSTF (1102b).

At step 5, the MBSTF (1102a) sends the session response including the ingress address to the NEFs/MBSFs (1008a) in the PLMN 1 (1106a). Similarly, the MBSTF (1102b) sends the session response including the ingress address to the NEFs/MBSFs (1008b) in the PLMN 1 (1106b).

At step 6, the NEFs/MBSFs (1008a) in the PLMN 1 (1106a) sends a Nnef_MBSSession_Create Response including the ingress address to the AF apparatus. Similarly, the NEFs/MBSFs (1008b) in the PLMN 1 (1106b) sends a Nnef_MBSSession_Create Response including the ingress address to the AF apparatus.

Referring to FIG. 11, the AF apparatus performs the MTK (MBS Traffic Key) generation and provides the MTK for all deployment scenarios. When the MTK is derived by the AF apparatus and is provided it to the PLMNs, then all the PLMNs of the MOCN will distribute the same MTK to all the MBS authorized UEs it serves. The UEs in a shared RAN even if the serving PLMN are different, will have the same MTK and UEs will be able to handle the protected content even if it is protected by the non-serving PLMN.

Embodiments disclosed herein provide a method for performing key update and distribution in a MOCN when a service layer protection is supported. The method includes determining, by a CN apparatus, a need for a MBS key update in at least one first network apparatus or at least one second network apparatus from a plurality of network apparatuses. Further, the method includes triggering, by the CN apparatus, a key update procedure for a MTK and a MTK ID at the at least one first network apparatus or the at least one second network apparatus from the plurality of network apparatuses. Further, the method includes receiving, by an AF apparatus, a key update request message from the at least one first network apparatus or the at least one second network apparatus from the plurality of network apparatuses to provide an updated MTK and the MTK ID common to the CN apparatus participating in the MOCN. Further, the method includes generating, by the AF apparatus, a new MTK and a new MTK ID common to the participating CN apparatus in the MOCN. The new MBS Traffic key is derived based on the key update request message received from the at least one first network apparatus or the at least one second network apparatus from the plurality of network apparatuses. Further, the method includes sending, by the AF apparatus, the new MTK to the at least one first network apparatus and the at least one second network apparatus via the CN apparatus. Further, the method includes receiving, by the CN apparatus, the at least one first network apparatus or the at least one second network apparatus, the new MBS Traffic Key (MTK) and the new MTK ID common to the participating CN apparatus in the MOCN.

Based on the proposed method, the MTK update/refresh for the MOCN scenario can be triggered by the MBSTF and/or MBSF and/or by the AF. The proposed method also includes a mechanism for the key distribution in MBS with/without MOCN capability. Considering a scenario where a PLMN1 does not have MOCN capability and a PLMN2 has both MBS and MOCN capability. The alternative proposes a mechanism to provide the MTK keys for the case where one PLMN does not support the MOCN capability. In the case, the MBSF/MBSTF in PLMN 1 generates the MTK key and provide it to the AF apparatus. Then the AF apparatus checks whether the PLMN2 is having MOCN capability or not. The AF apparatus then provides the MTK received from MBSF/MBSTF PLMN1 to the MBSF/MBSTF in PLMN 2.

In another embodiment, both the PLMNs supports both the MOCN capability and the MBS capability. A Key management Server (KMS) is used to maintain and download the MTK. The key management client at the MBSTF/MBSF sends an URL request for key material i.e., MTK from the KMS.

In an embodiment, the MTK key is stored at the KMS and the MBSF in PLMN 1 and MBSF in PLMN 2 fetches the MTK key from the KMS. In another embodiment, the MTK key is stored at the KMS and the MBSTF in PLMN 1 and MBSTF in PLMN 2 fetches the MTK key from the KMS.

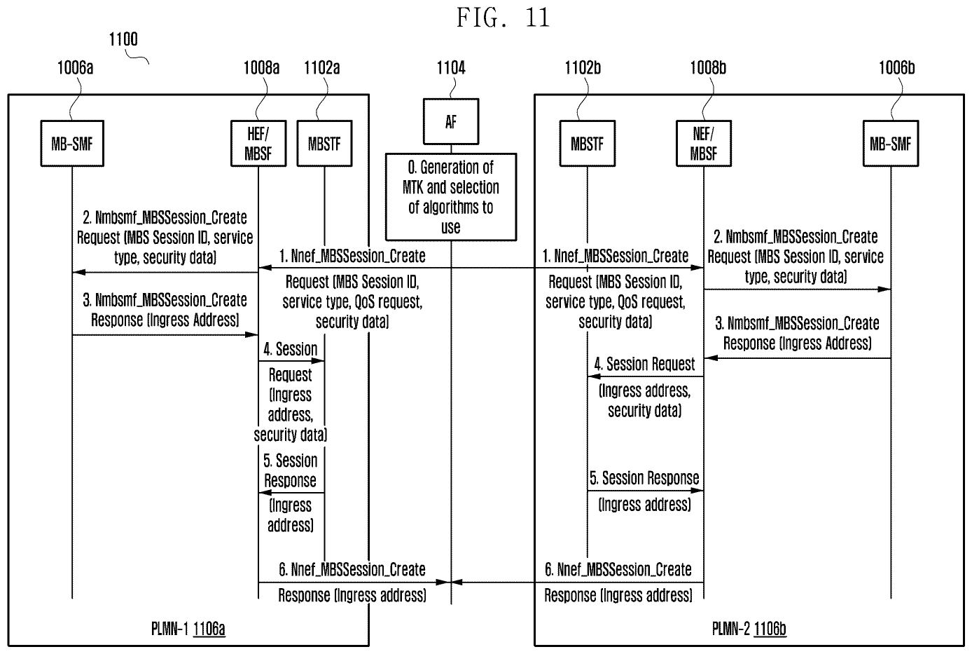

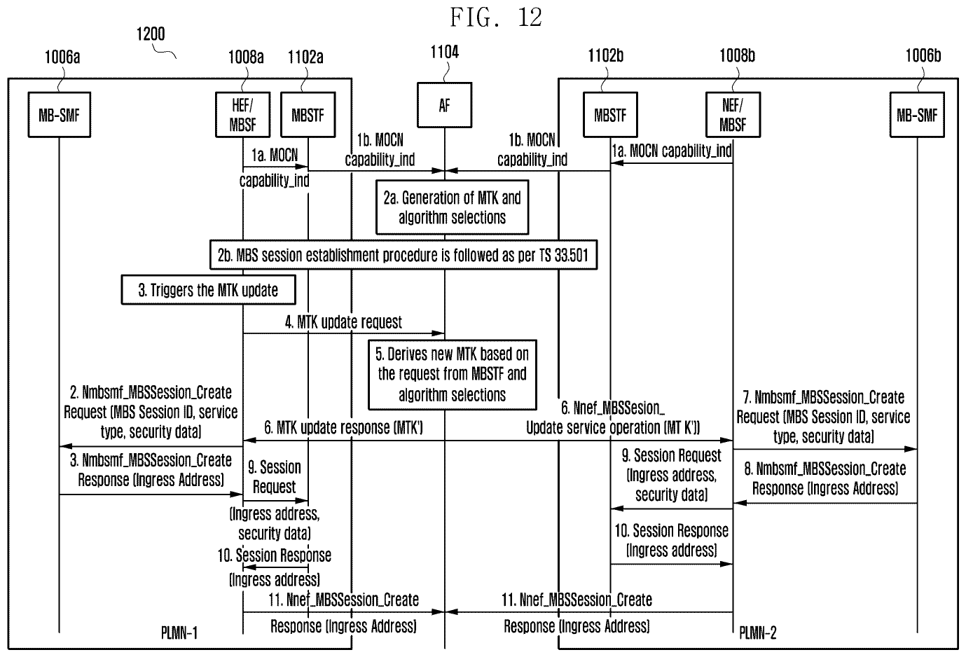

Referring now to the drawings, and more particularly to FIGS. 12 through 16, there are shown preferred embodiments.

FIG. 12 shows a schematic diagram of method for triggering MTK update/refresh for the MOCN (1200) by the MBSTF (1102a, 1102b)/MBSF (1008a, 1008b)/an AF apparatus (1104), according to the embodiments as disclosed herein. The detailed procedure is explained below:

At step 1, when a PLMN1 (1106a) and/or a PLMN 2 (1106b) supports the MOCN capability, PLMN1 (1106a) and/or a PLMN 2 (1106b) will send the indication to the AF apparatus (1104). The indication is sent by the MBSF (1008a, 1008b)/MBSTF (1102a, 1102b) over Nmb2/Nmb8 to the AF apparatus (1104). In an embodiment, a new service operation is proposed to indicate the MOCN capability from the MBSF/MBSTF to the AF apparatus (1104).
Nmbsf_MOCN_capability service operation
Service operation name: Nmbsf_MOCN_Capability
Description: This service is used by the MBSF to indicate the MOCN capability to the AF
Inputs, Required: MOCN capability Ind
Inputs, Optional: None
Outputs, Required: None
Outputs, Optional: None.

In another embodiment, the existing service operation is proposed to indicate the MOCN capability from the MBSF (1008a, 1008b)/MBSTF (1102a, 1102b) to the AF apparatus (1104).

At step 2a-2b, the AF apparatus (1104) generates the MTK and selects the security algorithm for the MBS session ID. The AF apparatus (1104) provides the security data (MTK, MTK ID and selected algorithm(s)) to the NEF/MBSF (1008a, 1008b). The MBS session establishment procedure is performed as described in TS 33.501.

At step 3, the MBSF (1008a, 1008b) or the MB-SMF (1006a, 1006b) determines the need for the MTK refresh/update (the trigger for refresh can be MTK is expired or about to expire or there is change of the authorization information or based on the local policy (too long use of the key, like so)) and the MBSF (1008a) or MB-SMF (1006a) in the PLMN1 (1106a) may trigger the MTK update procedure by requesting the AF apparatus (1104) to provide a new fresh MTK.

At step 4, the MBSF (1008a) sends a key update request message to AF apparatus (1104) directly or via the MBSTF (1102a). The key update request message shall include the MBS session ID.

In an embodiment, the existing message Nmbsmf_TMGI_Allocate service operation is used for triggering the MTK update request by the MBSF (1008a) to the AF apparatus (1104). The key update request message includes following:
Nmbsmf_TMGI_Allocate service operation,
Service operation name: Nmbsmf_TMGI_Allocate,
Description: This service is used by the NF Service Consumer to request the allocation of TMGI(s) or request to refresh previously allocated TMGI(s) and to trigger the MTK update.
Inputs, Required: Number of TMGIs, MTK update trigger ind
Inputs, Optional: TMGI(s) (i.e. the TMGI(s) to be extended the expiry time).
Outputs, Required: TMGI(s), Expiry Time of the TMGI(s), MTK′.
Outputs, Optional: None.

In an embodiment, a new Nmbsmf or Nnef service is used for requesting the MTK update/refresh by the MBSF to the AF.

At step 5, the AF apparatus (1104) generates the new MTK key (MTK′) and perform the algorithm selection upon receiving the request from the MBSF (1008a)/MBSTF (1102a).

At step 6, the AF apparatus (1104) provides the security data (MTK′, MTK′ ID and selected algorithm(s)) to the NEF/MBSF (1008a, 1008b) in the existing message i.e., Nnef_MBSSession_create request or a using a new message Nnef_MBSKeyRegister request. Upon receiving the MTK, the network performs the MTK distribution mechanism as detailed in 3GPP TS 33.501 and may use it to protect the MBS content.

In another embodiment, the AF apparatus (1104) provides the security data (MTK′, MTK′ ID and selected algorithm(s)) to the NEF/MBSF (1008a, 1008b) in the Nnef_MBSSession_Update request.

As the MTK in PLMN 1 (1106a) is updated, the MTK in PLMN 2 (1106b) should also be updated. Therefore, the AF apparatus (1104) triggers/initiate the MTK update procedure for the PLMN2 (1106b) by sending the updated MTK to the NEF/MBSF in PLMN 2 (1106b) in the existing message i.e., Nnef_MBSSession_create request or a new message Nnef_MBSKeyRegister request or in the Nnef_MBSSession_Update request.

In an embodiment, the AF apparatus (1104) itself triggers the MTK update procedure based on local policy and provides new generated MTK key to the PLMNs which are participating in the MOCN (1200).

At step 7-8, the MBSF (1008a, 1008b) includes the received security data in the multicast/broadcast session security context and provides it to the MB-SMF. The SMF obtains the multicast session security context from the MB-SMF and provides it to the UE, as specified in TS 33.501.

At step 9-10, the NEF/MBSF (1008a, 1008b) provides the received security data to the MBSTF. Upon receiving the security data from the NEF/MBSF (1008a, 1008b), the MBSTF (1102a) uses the provided MTK for MBS traffic protection, instead of deriving a MTK for the specified MBS session ID.

At step 11, the NEF/MBSF (1008a, 1008b) provides response for the received Nnef_MBSSession_Create request. MTK distribution for the case where one of the PLMN does not have MOCN capability

Considering a scenario where the PLMN1 (1106a) does not have MOCN capability and the PLMN2 (1106b) has both MBS and MOCN capability. The alternative proposes a mechanism to provide the MTK keys for the case where one PLMN does not support the MOCN capability.

In this case, the MBSF (1008a)/MBSTF (1102a) in the PLMN1 (1106a) generates the MTK key and provide it to the AF apparatus (1104). Then the AF apparatus (1104) checks whether the PLMN2 (1106b) is having MOCN capability or not. The AF apparatus (1104) then provides the MTK received from the MBSF/MBSTF in the PLMN1 (1106a) to the MBSF/MBSTF in the PLMN2 (1106b).

MTK distribution for the MOCN scenario: In an embodiment, both the PLMNs supports both the MOCN capability and the MBS capability. A Key management Server (KMS) is used to generate, maintain and download the MTK. In an embodiment, the Key management client at the MBSTF/MBSF sends an URL request for key material i.e., MTK from the KMS.

In an embodiment, the MTK key is stored at the KMS and the MBSF in the PLMN1 (1106a) and MBSF in PLMN2 (1106b) fetches the MTK key from the KMS. In another embodiment, the MTK key is stored at the KMS and the MBSTF in PLMN1 (1106a) and MBSTF in PLMN2 (1106b) fetches the MTK key from the KMS.

In another embodiment, the AF apparatus (1104) provides the details of the KMS to the network entity (MB-SMF and/or MBSF and/or MBSTF). The details of the KMS can be at least one of: IP address, FQDN, KMSuri. The details of the KMS is included in Nnef message, for illustrative purpose, the Nnef message being Nnef_MBSSession_Create Request. Upon receiving the details of the KMS, the network entity (MB-SMF and/or MBSF and/or MBSTF) request the appropriate KMS to provide the MTK. The request to the KMS includes the MBS session ID and MBS session ID is used to uniquely identify the MTK and MTK ID. The KMS provides the MTK and MTK ID to the network entity. In an embodiment, the network entity connection to the KMS is over HTTP.

In case of the MTK refresh, the NEF/MBSF/MBSTF/AF request the KMS to refresh the key. Upon receiving the request, the KMS refresh the MTK and provides the new MTK. Further KMS indicate the corresponding AF (if not triggered by the AF), about the status of the key update. In an embodiment, upon receiving the indication/information from the KMS that the MTK is refreshed in the KMS, the AF indicate the key refreshed status to all PLMNs of the MOCN (1200) to retrieve the MTK key and distribution.

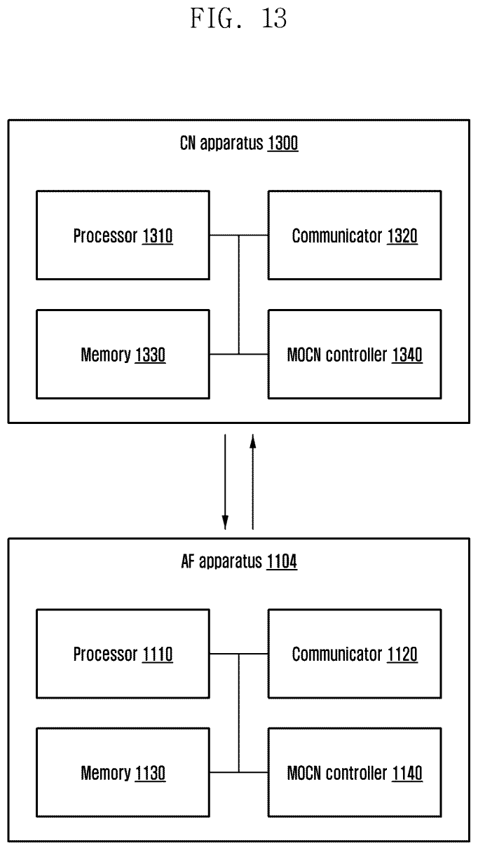

FIG. 13 illustrates an overview (1300) of the MOCN (1200) for performing key update and distribution, according to the embodiments as disclosed herein. The MOCN (1200) includes a CN apparatus (1300) and the AF apparatus (1104). The CN apparatus (1300) and the AF apparatus (1104) communicate with each other.

In an embodiment, the CN apparatus (1300) includes a processor (1310), a communicator (1320), a memory (1330) and a MOCN controller (1340). The processor (1310) is coupled with the communicator (1320), the memory (1330) and the MOCN controller (1340).

The MOCN controller (1340) determines the need for the MBS key update in a first network apparatus or a second network apparatus from the plurality of network apparatuses. Further, the MOCN controller (1340) triggers the update procedure for the MTK and the MTK ID at the first network apparatus or the second network apparatus from the plurality of network apparatuses key.

The MOCN controller (1340) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (1310) is configured to execute instructions stored in the memory (1330) and to perform various processes. The communicator (1320) is configured for communicating internally between internal hardware components and with external devices via one or more networks. The memory (1330) also stores instructions to be executed by the processor (1310). The memory (1330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (1330) may, in some examples, be considered a non-transitory storage medium. The term “non-transitory” may indicate that the storage medium is not embodied in a carrier wave or a propagated signal. However, the term “non-transitory” should not be interpreted that the memory (1330) is non-movable. In certain examples, a non-transitory storage medium may store data that can, over time, change (e.g., in Random Access Memory (RAM) or cache).

In an embodiment, the AF apparatus (1104) includes a processor (1110), a communicator (1120), a memory (1130) and a MOCN controller (1140). The processor (1110) is coupled with the communicator (1120), the memory (1130) and the MOCN controller (1140).

The MOCN controller (1140) receives a key update request message from the first network apparatus or the second network apparatus from the plurality of network apparatuses to provide the updated MTK and the MTK ID common to the CN apparatus (1300) participating in the MOCN. In an embodiment, the key update request message is received from the MBSF or the MBSTF in the first network apparatus. In an embodiment, the key update request message includes at least one of: a Nmbsmf_TMGI_Allocate request message, a Nmbsmf request message, and a Nnef service request message.

Further, the MOCN controller (1140) generates a new MTK and a new MTK ID common to the participating CN apparatus in the MOCN. The new MBS Traffic key is derived based on the key update request message received from the first network apparatus or the second network apparatus from the plurality of network apparatuses. Further, the MOCN controller (1140) sends the new MTK to the first network apparatus and the second network apparatus via the CN apparatus (1300). The MOCN controller (1340) of the CN apparatus (1300) receives, the first network apparatus or the second network apparatus, the new MTK and the new MTK ID common to the participating CN apparatus in the MOCN.

In an embodiment, the need for the MBS key update is triggered based on an event. The event can be, for example, but not limited to an expiry of the MTK, the MTK is about to expire, a change of authorization information, a trigger based on a local policy, use of the MTK for a predefined time period.

In an embodiment, the new MTK is sent to the first network apparatus in a key update response message. In an embodiment, the key update response message includes at least one of a Nmbsmf_TMGI_Allocate response message, a Nmbsmf response message and a Nnef service response message.

In an embodiment, the updated MTK in the first network apparatus or the second network apparatus is sent using at least one of a Nnef_MBSSession_create request or a Nnef_MBSKeyRegister request or a Nnef_MBSSession_Update request. In an cm-bodiment, the new MTK is sent to the second network apparatus in a MBS session update service operation message. In an embodiment, the MTK update request message includes an identifier of the MBS session.

The MOCN controller (1140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (1110) is configured to execute instructions stored in the memory (1130) and to perform various processes. The communicator (1120) is configured for communicating internally between internal hardware components and with external devices via one or more networks. The memory (1130) also stores instructions to be executed by the processor (1110). The memory (1130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (1130) may, in some examples, be considered a non-transitory storage medium. The term “non-transitory” may indicate that the storage medium is not embodied in a carrier wave or a propagated signal. However, the term “non-transitory” should not be interpreted that the memory (1130) is non-movable. In certain examples, a non-transitory storage medium may store data that can, over time, change (e.g., in Random Access Memory (RAM) or cache).

Although the FIG. 13 shows various hardware components of the MOCN (1200) but it is to be understood that other embodiments are not limited thereon. In other embodiments, the MOCN (1200) may include less or more number of components. Further, the labels or names of the components are used only for illustrative purpose and does not limit the scope of the invention. One or more components can be combined together to perform same or substantially similar function in the MOCN (1200).

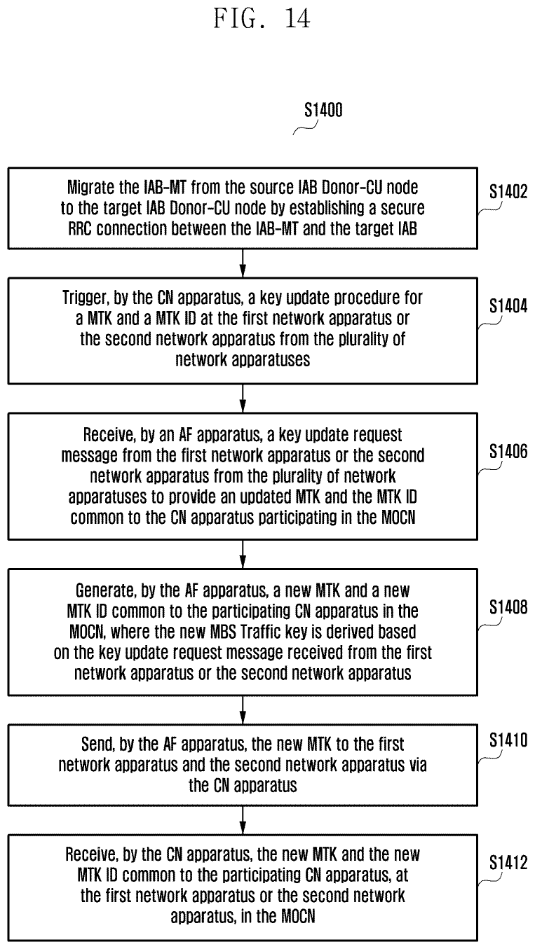

FIG. 14 is a flow chart (S1400) illustrating a method for performing key update and distribution in the MOCN (1200), when a service layer protection is supported, according to the embodiments as disclosed herein.

At S1402, the method includes determining, by the CN (1300) apparatus, the necd for the MBS key update in the first network apparatus or the second network apparatus from the plurality of network apparatuses. At S1404, the method includes triggering, by the CN apparatus (1300), the key update procedure for the MTK and the MTK ID at the first network apparatus or the second network apparatus from the plurality of network apparatuses. At S1406, the method includes receiving, by the AF apparatus (1104), the key update request message from the first network apparatus or the second network apparatus from the plurality of network apparatuses to provide the updated MTK and the MTK ID common to the CN apparatus participating in the MOCN (1200). At S1408, the method includes generating, by the AF apparatus (1104), the new MTK and the new MTK ID common to the participating CN apparatus in the MOCN (1200). The new MBS Traffic key is derived based on the key update request message received from the first network apparatus or the second network apparatus from the plurality of network apparatuses. At S1410, the method includes sending, by the AF apparatus (1104), the new MTK to the first network apparatus and the second network apparatus via the CN apparatus. At S1412, the method includes receiving, by the CN apparatus (1300), the first network apparatus or the second network apparatus, the new MTK and the new MTK ID common to the participating CN apparatus in the MOCN (1200).

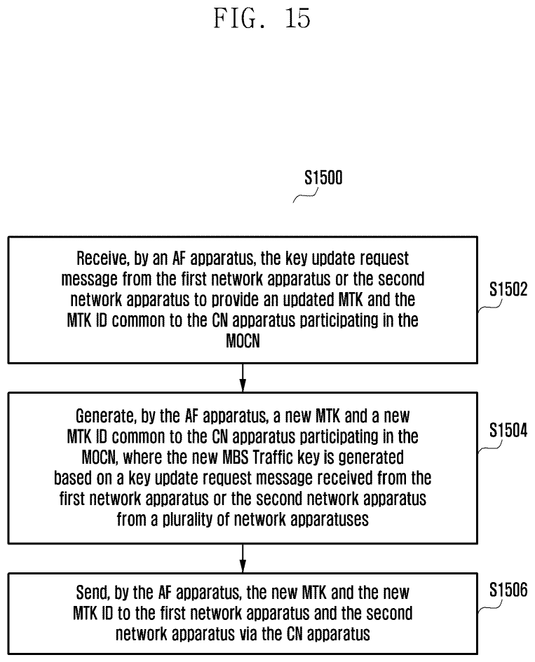

FIG. 15 is a flow chart (S1500) illustrating a method, implemented by the AF apparatus (1104), for performing key update and distribution in the MOCN (1200) when the service layer protection is supported, according to the embodiments as disclosed herein. The operations (S1502-S1506) are handled by the MOCN controller (1140).

At S1502, the method includes receiving the key update request message from the first network apparatus or the second network apparatus to provide the updated MTK and the MTK ID common to the CN apparatus participating in the MOCN (1200). At S1504, the method includes generating the new MTK and the new MTK ID common to the CN apparatus (1300) participating in the MOCN (1200). The new MBS Traffic key is generated based on the key update request message received from the first network apparatus or the second network apparatus from the plurality of network apparatuses. At S1506, the method includes sending the new MTK and the new MTK ID to the first network apparatus and the second network apparatus via the CN apparatus (1300).

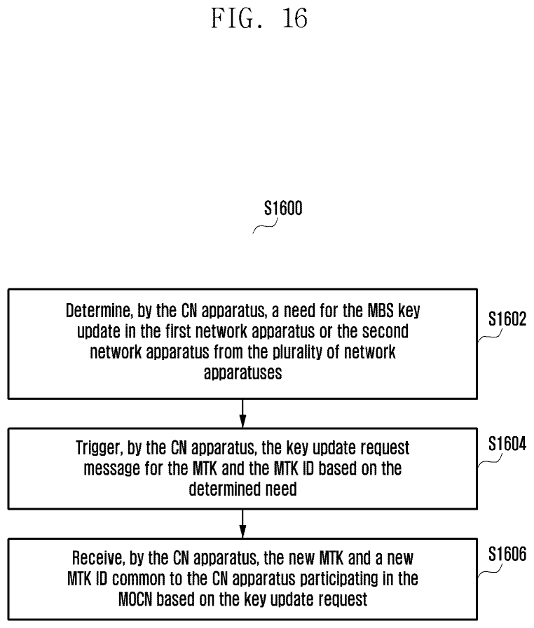

FIG. 16 is a flow chart (S1600) illustrating a method, implemented by the CN apparatus (1300), for performing key update and distribution in the MOCN (1200) when the service layer protection is supported, according to the embodiments as disclosed herein. The operations (S1602-S1606) are handled by the MOCN controller (1340).

At S1602, the method includes determining the need for the MBS key update in the first network apparatus or the second network apparatus from the plurality of network apparatuses. At S1604, the method includes triggering the key update request message for the MTK and the MTK ID based on the determined need. At S1606, the method includes receiving the new MTK and the new MTK ID common to the CN apparatus participating in the MOCN (1200) based on the key update request.

The proposed method ensures to support the MTK refresh/MTK update mechanism for the PLMNs, which are under the MOCN, where the AF apparatus (1104) needs to be indicated about the support of MOCN by a particular PLMN, by providing the MTK keys to the PLMNs with/without MOCN capability and without affecting the service in the MOCN (1200).

The various actions, acts, blocks, steps, or the like in the flow chart (S1400-S1600) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method performed by a source IAB Donor-Control Unit (CU) in a wireless network, the method comprising:
identifying a migration of a IAB-Mobile Termination (MT) from the source IAB Donor-CU to a target IAB Donor-CU, wherein the IAB-MT remains connected to the source IAB Donor-CU via a F1 connection and establishes radio resource control (RRC) connection with the target IAB Donor-CU;
retaining a security context associated with the F1 connection of the IAB-MT; and
migrating the IAB-MT from the source IAB Donor-CU to the target IAB Donor-CU by establishing a secure RRC connection between the IAB-MT and the target IAB Donor-CU.

2. The method of claim 1, further comprising:
performing a IKEv2 authentication with the IAB-MT based on a Pre-Shared Secret Key (PSK) associated with at least one old IP address, wherein the at least one old IP address is associated with the F1 connection.

3. The method of claim 2,
wherein the PSK is identified by a gNB-Distributed Unit (DU) ID.

4. The method of claim 1, further comprising:
in case of multiple transport network layer (TNL) addresses, mapping between old TNL addresses with new TNL addresses based on a TNL address index.

5. The method of claim 1, further comprising:
receiving, from the IAB-MT, a F1-U gNB-DU configuration update message.

6. A source IAB Donor-Control Unit (CU) in a wireless network, the source IAB Donor-CU comprising:
a memory;
a processor and
a controller communicatively coupled to the memory and the processor, configured to;
identify a migration of a IAB-Mobile Termination (MT) from the source IAB Donor-CU to a target IAB Donor-CU, wherein the IAB-MT remains connected to the source IAB Donor-CU via a F1 connection and establishes radio resource control (RRC) connection with the target IAB Donor-CU,
retain a security context associated with the F1 connection of the IAB-MT, and
migrate the IAB-MT from the source IAB Donor-CU to the target IAB Donor-CU by establishing a secure RRC connection between the IAB-MT and the target IAB Donor-CU.

7. The source IAB Donor-CU of claim 6,
wherein the controller is further configured to;
perform a IKEv2 authentication with the IAB-MT based on a Pre-Shared Secret Key (PSK) associated with at least one old IP address, wherein the at least one old IP address is associated with the F1 connection.

8. The source IAB Donor-CU of claim 7,
wherein the PSK is identified by a gNB-Distributed Unit (DU) ID.

9. The source IAB-Donor CU of claim 6,
wherein the controller is further configured to:
in case of multiple transport network layer (TNL) addresses, map between old TNL addresses with new TNL addresses based on a TNL address index.

10. The source IAB-Donor CU of claim 6,
wherein the controller is further configured to:
receive, from the IAB-MT, a F1-U gNB-DU configuration update message.
